(19) United States
(12) Patent Application Publication
(10) Pub. No.: US 2012/0086742 A1
(43) Pub. Date: Apr. 12, 2012

(54) DISPLAY APPARATUS

(75) Inventors: Kouji Ikeda, Chiba-shi (JP); Tatsuhito Goden, Chiba-shi (JP); Hajime Akimoto, Kokubunji-shi (JP)

(73) Assignees: HITACHI DISPLAYS, LTD., Mobara-shi (JP); CANON KABUSHIKI KAISHA, Tokyo (JP)

(21) Appl. No.: 13/251,525

(22) Filed: Oct. 3, 2011

(30) Foreign Application Priority Data
Oct. 7, 2010 (JP) 2010-227208
Sep. 26, 2011 (JP) 2011-208917

(51) Int. Cl. G09G 5/10

(52) U.S. Cl. 345/691; 345/690

(57) ABSTRACT

A gradation display apparatus includes: a plurality of pixels, each including a light emitting element, a driving transistor, and a storage capacitor; a data line; a reference voltage line; and a control circuit. During a one frame period, the control circuit supplies a data voltage to each of the pixels through the data line, to write the data voltage in the storage capacitor, and, thereafter, supplies to the reference voltage line respectively different first and second voltages successively in this order or reversed order, so that, in each of the pixels, a sum of a light emitting quantity of the light emitting element during a period of supplying the first voltage and a light emitting quantity of the light emitting element during a period of supplying the second voltage equals to a predetermined light emitting quantity of the light emitting element predetermined according to image data.

### BACKGROUND OF THE INVENTION

1. Field of the Invention

The present invention relates to a display apparatus including self-light-emitting elements arranged in a matrix.

2. Description of the Related Art

A self-light-emitting display apparatus represented by an organic EL element includes a plurality of pixels made of self-light-emitting elements arranged on a substrate in a matrix. The amount of current or voltage applied to the self-light-emitting elements of the pixels needs to be accurately controlled to accurately display the gradation on the pixels in a driving circuit of the self-light-emitting display apparatus. In general, the self-light-emitting display apparatus has an active matrix configuration including a switching element (active element), such as a transistor (Tr), in each pixel. Gradation display data corresponding to the light emitting quantity is usually once programmed for the pixels in each frame to cause the self-light-emitting elements of the pixels to emit light at desired luminance.

There are differences in the light emitting intensity of the pixels due to variations in characteristics of Tr, such as threshold voltage (Vth) and mobility (p). Luminance unevenness of display and stripe shapes are therefore generated, degrading the image quality. Japanese Patent Application Laid-Open No. 2004-341144 proposes a display apparatus as a technique for suppressing the variations in the characteristics of Tr. The display apparatus includes threshold canceling circuits arranged for all displayed pixels to prevent the influence of the variations in Vth.

However, although the pixel circuits disclosed in Japanese Patent Application Laid-Open No. 2004-341144 can cancel the variations in Vth of Tr, the variations in the mobility cannot be canceled. Furthermore, Vth cannot be sufficiently canceled if the time for Vth canceling is short. Therefore, there is a problem that the luminance unevenness of display cannot be sufficiently suppressed.

### SUMMARY OF THE INVENTION

As a result of studies, the present inventors have found out that the luminance unevenness of display can be suppressed by emitting light at two kinds of luminance levels.

An object of the present invention is to provide a display apparatus and a driving method of the display apparatus, the display apparatus suppressing the luminance unevenness by writing gradation display data in one gradation display datum once to emit light at two kinds of luminance levels according to the gradation display data to be displayed.

In order to achieve the above object, according to a first aspect of the present invention, a display apparatus comprises: a plurality of pixels, each including a light emitting element, a driving transistor for supplying the light emitting element with a current according to a voltage of a gate electrode of the driving transistor, and a storage capacitor having an one terminal connected to the gate electrode of the driving transistor for holding the voltage of the gate electrode of the driving transistor; a data line for supplying a data voltage according to an image data to the gate electrode of the driving transistor; a reference voltage line for supplying a reference voltage to the gate electrode of the driving transistor; and a control circuit for controlling the data voltage supplied through the data line, and for controlling the reference voltage supplied through the reference voltage line, wherein, during a one frame period, the control circuit supplies the data voltage through the data line to each of the pixels through the data line, to write the data voltage in the storage capacitor, and, thereafter, supplies to the reference voltage line respectively different first and second voltages successively in this order or reversed order, so that, in each of the pixels, a sum of a light emitting quantity of the light emitting element during a period of supplying the first voltage and a light emitting quantity of the light emitting element during a period of supplying the second voltage equals to a predetermined light emitting quantity of the light emitting element predetermined according to the image data.

In order to achieve the above object, according to a second aspect of the present invention, a display apparatus comprises: a plurality of pixels, each including a light emitting element, a driving transistor for supplying the light emitting element with a current according to a voltage of a gate electrode of the driving transistor, and a storage capacitor having an one terminal connected to the gate electrode of the driving transistor for holding the voltage of the gate electrode of the driving transistor; a data line for supplying a data voltage according to an image data to the gate electrode of the driving transistor; a reference voltage line for supplying a reference voltage to the gate electrode of the driving transistor; a control circuit for controlling the data voltage supplied through the data line, and for controlling the reference voltage supplied through the reference voltage line; and an image data determining unit for determining as to whether the image data is a high luminance data or a low luminance data based on an average luminance of the image data, wherein, during a one frame period, the control circuit supplies the data voltage through the data line to each of the pixels through the data line, to write the data voltage in the storage capacitor, and, thereafter, supplies to the reference voltage line respectively different first and second voltages determined based on a result of the determination by the image data determining unit, successively in this order or reversed order, so that, in each of the pixels, a sum of a light emitting quantity of the light emitting element during a period of supplying the first voltage and a light emitting quantity of the light emitting element during a period of supplying the second voltage equals to a predetermined light emitting quantity of the light emitting element predetermined according to the image data.

In order to achieve the above object, according to a third aspect of the present invention, a display apparatus comprises: a plurality of pixels, each including a light emitting element, a driving transistor for supplying the light emitting element with a current according to a voltage of a gate electrode of the driving transistor, and a storage capacitor having an one terminal connected to the gate electrode of the driving transistor for holding the voltage of the gate electrode of the driving transistor; a data line for supplying a data voltage according to an image data to the gate electrode of the driving transistor; a reference voltage line for supplying a reference voltage to the gate electrode of the driving transistor; a control circuit for controlling the data voltage supplied through the data line, and for controlling the reference voltage supplied through the reference voltage line; and an image data determining unit for determining as to whether the image data is a high luminance data or a low luminance data based on an average luminance of the image data, wherein, during a one frame period, the control circuit supplies the data voltage through the data line to each of the pixels through the data line, to write the data voltage in the storage capacitor, and, thereafter, in response to the determination as the high luminance data by the image data determining unit, supplies a predetermined voltage to the reference voltage line, and, in response to the determination as the low luminance data by the image data determining unit, supplies to the reference voltage line respectively different first and second voltages successively in this order or reversed order, so that, at the time of the determination as the high luminance data, in each of the pixels, a light emitting quantity of the light emitting element during a period of supplying the predetermined voltage equals to the predetermined light emitting quantity of the light emitting element predetermined according to the image data, while, at the time of the determination as the low luminance data, in each of the pixels, a sum of a light emitting quantity of the light emitting element during a period of supplying the first voltage and a light emitting quantity of the light emitting element during a period of supplying the second voltage equals to a predetermined light emitting quantity of the light emitting element predetermined according to the image data.

In order to achieve the above object, according to a fourth aspect of the present invention, a driving method of a display apparatus comprising: a plurality of pixels, each including a light emitting element, a driving transistor for supplying the light emitting element with a current according to a voltage of a gate electrode of the driving transistor, and a storage capacitor for holding the voltage of the gate electrode of the driving transistor; a plurality of data lines for supplying a data voltage according to an image data to the gate electrode of the driving transistor; and a plurality of reference voltage lines for supplying a reference voltage to the gate electrode of the driving transistor, comprises steps of: supplying the data voltage through the data line to each of the pixels, one frame period by one frame period, to write the data voltage in the storage capacitor, and, thereafter, supplying to the reference voltage line respectively different first and second voltages successively in this order or reversed order; and setting a sum of a light emitting quantity of the light emitting element during a period of supplying the first voltage and a light emitting quantity of the light emitting element during a period of supplying the second voltage equals to a predetermined light emitting quantity of the light emitting element predetermined according to the image data.

In order to achieve the above object, according to a fifth aspect of the present invention, a driving method of a display apparatus comprising: a plurality of pixels, each including a light emitting element, a driving transistor for supplying the light emitting element with a current according to a voltage of a gate electrode of the driving transistor, and a storage capacitor for holding the voltage of the gate electrode of the driving transistor; a plurality of data lines for supplying a data voltage according to an image data to the gate electrode of the driving transistor; a plurality of reference voltage lines for supplying a reference voltage to the gate electrode of the driving transistor; and an image data determining unit for determining as to whether the image data is a high luminance data or a low luminance data based on an average luminance of the image data, comprises steps of: supplying the data voltage through the data line to each of the pixels, one frame period by one frame period, to write the data voltage in the storage capacitor, and, thereafter, supplying to the reference voltage line respectively different first and second voltages determined based on a result of the determination by the image data determining unit, successively in this order or reversed order; and setting a sum of a light emitting quantity of the light emitting element during a period of supplying the first voltage and a light emitting quantity of the light emitting element during a period of supplying the second voltage equals to a predetermined light emitting quantity of the light emitting element predetermined according to the image data.

In order to achieve the above object, according to a sixth aspect of the present invention, a driving method of a display apparatus comprising: a plurality of pixels, each including a light emitting element, a driving transistor for supplying the light emitting element with a current according to a voltage of a gate electrode of the driving transistor, and a storage capacitor for holding the voltage of the gate electrode of the driving transistor; a plurality of data lines for supplying a data voltage according to an image data to the gate electrode of the driving transistor; a plurality of reference voltage lines for supplying a reference voltage to the gate electrode of the driving transistor; and an image data determining unit for determining as to whether the image data is a high luminance data or a low luminance data based on an average luminance of the image data, comprises steps of: supplying the data voltage through the data line to each of the pixels, one frame period by one frame period, to write the data voltage in the storage capacitor, and, thereafter, supplying a predetermined voltage to the reference voltage line, in response to the determination as the high luminance data by the image data determining unit; supplying to the reference voltage line respectively different first and second voltages successively in this order or reversed order, in response to the determination as the low luminance data by the image data determining unit; setting, in each of the pixels, a light emitting quantity of the light emitting element during a period of supplying the predetermined voltage as being equal to the predetermined light emitting quantity of the light emitting element predetermined according to the image data, at the time of the determination as the high luminance data while setting, in each of the pixels, a sum of a light emitting quantity of the light emitting element during a period of supplying the first voltage and a light emitting quantity of the light emitting element during a period of supplying the second voltage as being equal to a predetermined light emitting quantity of the light emitting element predetermined according to the image data, at the time of the determination as the low luminance data.

According to the present invention, the luminance unevenness of the display apparatus can be suppressed by emitting light at two kinds of luminance levels for one gradation display datum. A reference voltage is changed when one gradation display datum is emitted at two kinds of luminance levels. In this way, just one time of writing of the gradation display data is required, and a sufficiently long time for writing to the pixels can be secured.

Further features of the present invention will become apparent from the following description of exemplary embodiments with reference to the attached drawings.

### BRIEF DESCRIPTION OF THE DRAWINGS

FIG. 1 is a diagram illustrating an example of a display apparatus of the present invention.

FIG. 2 is a diagram illustrating an example of a pixel circuit suitably used for the display apparatus of the present invention.

FIG. 3 is a diagram illustrating a driving method of the prior art of the pixel circuit of FIG. 2.

FIGS. 4A, 4B and 4C are diagrams illustrating examples of light emitting patterns of the present invention and light emitting patterns of the prior art.

FIG. 5 is a diagram illustrating Vg-Id characteristics of a PMOS transistor.

FIG. 6 is a diagram illustrating a relationship between luminance and a stripe shape unevenness ratio of the display apparatus.

FIG. 7 is a diagram illustrating a relationship between gradation and luminance in the light emitting patterns of the prior art.

FIG. 8 is a diagram illustrating a relationship between gradation and luminance in the light emitting patterns of the present invention.

FIG. 9 is a diagram illustrating an example of a driving method of the pixel circuit according to a first embodiment.

FIG. 10 is a diagram illustrating an example of transmission of video data according to the present invention.

FIGS. 11A and 11B are diagrams illustrating an example of light emitting patterns according to a second embodiment.

FIG. 12 is a diagram illustrating an example of a driving method at low luminance according to the second embodiment.

FIG. 13 is a diagram illustrating an example of another driving method at low luminance according to the second embodiment.

FIGS. 14A and 14B are diagrams illustrating an example of light emitting patterns according to a third embodiment.

FIG. 15 is a diagram illustrating an example of a driving method of the pixel circuit according to the third embodiment.

FIGS. 16A and 16B are diagrams illustrating an example of light emitting patterns according to a fourth embodiment.

FIG. 17 is a diagram illustrating an example of a driving method of the pixel circuit according to the fourth embodiment.

FIGS. 18A and 18B are diagrams illustrating an example of light emitting patterns according to a fifth embodiment.

FIG. 19 is a diagram illustrating an example of a driving method of the pixel circuit according to the fifth embodiment.

FIG. 20 is a diagram illustrating an example of the pixel circuit according to a sixth embodiment.

FIG. 21 is a diagram illustrating an example of a driving method at high luminance according to the sixth embodiment.

FIG. 22 is a diagram illustrating an example of a driving method at low luminance according to the sixth embodiment.

FIG. 23 is a diagram illustrating an example of transmission of video data according to the sixth embodiment.

FIG. 24 is a diagram illustrating another example of the pixel circuit according to the sixth embodiment.

FIG. 25 is a diagram illustrating an example of a driving method of the pixel circuit of FIG. 24 and a light emitting pattern.

FIG. 26 is a diagram illustrating an example of a driving method of the pixel circuit according to a seventh embodiment.

FIG. 27 illustrates a digital still camera system using the display apparatus of the present invention.

### DESCRIPTION OF THE EMBODIMENTS

Preferred embodiments of the present invention will now be described in detail in accordance with the accompanying drawings.

The present invention will now be described with an example of an organic EL display apparatus using organic

EL elements (OLED) as light emitting elements. However, the display apparatus of the present invention is not limited to this, and apparatuses that can control light emission of self-light-emitting elements can be applied.

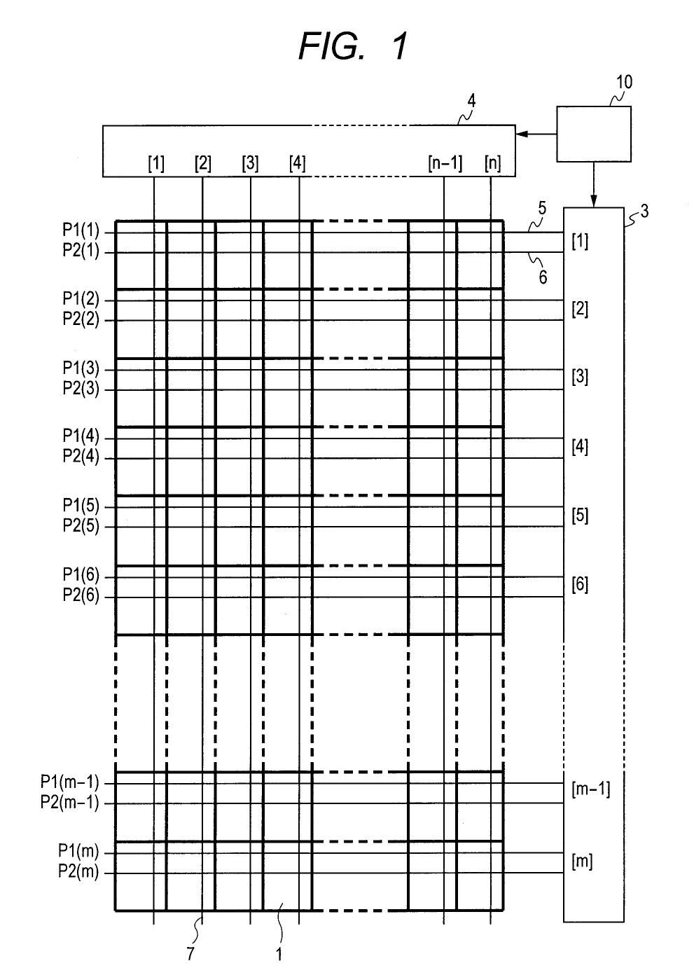

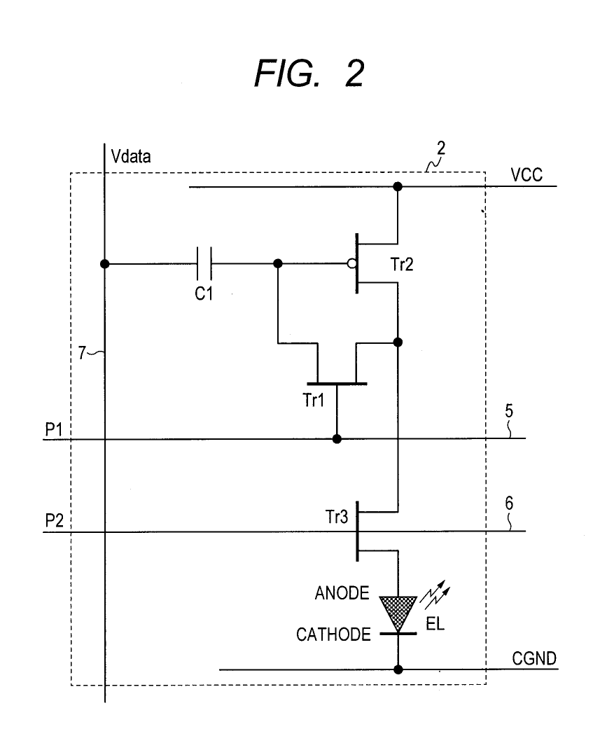

FIG. 1 illustrates an example of the display apparatus of the present invention and illustrates an overall configuration of the display apparatus. The display apparatus of FIG. 1 includes an image display unit (hereinafter, may be called “display area”) including pixels 1 arranged in a matrix of 3m rows×n columns (m and n are natural numbers). The pixel 1 includes an organic EL element, a driving transistor that supplies a current according to a voltage of a gate electrode to the organic EL element, and a storage capacitor that includes one end connected to the gate electrode of the driving transistor and that holds the voltage of the gate electrode. The organic EL element, the driving transistor, and the storage capacitor form a pixel circuit (see FIG. 2). In a full-color display apparatus, sets of pixels for displaying R, pixels for displaying G, and pixels for displaying B serve as display units, and the pixels are arranged on the image display unit.

The display apparatus of FIG. 1 includes a data line 7 that supplies a data voltage according to image data to the gate electrode of the driving transistor (the data line 7 also serves as a reference voltage line that supplies a reference voltage to the gate electrode of the driving transistor) and a control circuit.

Although the data line 7 also serves as the reference voltage line, the data line 7 and the reference voltage line may be separately arranged. The control circuit includes a row control circuit 3 that controls control signals P1 and P2 supplied to control lines 5 and 6, a column control circuit 4 that controls a data voltage supplied to the data line 7 and a reference voltage supplied to the reference voltage line, and a driver IC 10 that controls operations of the row control circuit 3 and the column control circuit 4. The control circuit may not have the configuration of FIG. 1 as long as the same functions as the row control circuit 3, the column control circuit 4, and the driver IC 10 are included.

The driver IC 10 inputs a control signal to the row control circuit 3, and each output terminal of the row control circuit 3 outputs a plurality of control signals P1(1) to P1(m) and P2(1) to P2(m) for controlling operations of the pixel circuits. The control signal P1 as one of the control signals output from the output terminals of the row control circuit 3 is input to the pixel circuits of the rows through the control line 5, and the control signal P2 as another control signal is input to a pixel circuit 2 of each row through the control line 6. Although the number of control lines output from the output terminals of the row control circuit 3 is two in FIG. 1, the number does not have to be two. The number of control lines may be one or three or more depending on the configuration of the pixel circuits 2.

The driver IC 10 inputs image data to the column control circuit 4, and the output terminals of the column control circuit 4 output a data voltage Vdata that is gradation display data according to the image data. The data voltage Vdata output from the column control circuit 4 is input to the pixel circuits 2 of the columns through the data line 7. Although the column control circuit 4 is depicted near the display area in FIG. 1, the column control circuit 4 may be on another substrate such as COG as long as the column control circuit 4 is electrically connected. The image data here is original data of the voltage data input to all pixels forming one frame screen.

FIG. 2 illustrates an example of the pixel circuit that is suitably used in the display apparatus of the present invention and that includes a self-light-emitting element such as a generally known organic EL element. The pixel circuit 2 of FIG. 2 includes an organic EL element, a current supply circuit unit as a circuit that supplies a current according to the gradation display data to the organic EL element, a plurality of signal input wiring (control lines 5, 6, and data line 7) connected to the current supply circuit unit, and power supply wiring (+VCC wiring and CGND wiring).

The current supply circuit unit includes a driving transistor Tr2 that supplies a current according to the voltage of the gate electrode to the organic EL element and a transistor Tr1 that serves as a pixel circuit selecting unit that selects the pixel circuit 2 to be written and as a threshold compensation unit of the driving transistor Tr2. The current supply circuit unit further includes a storage capacitor C1 that holds the voltage of the gate electrode of the driving transistor Tr2, a transistor Tr3 as a light emitting period control unit, and a reference voltage line as a light emitting intensity control unit.

The data line 7 that supplies the data voltage Vdata is a reference voltage/data line that also serves as a reference voltage line that supplies a reference voltage (Vref) to the gate electrode of the driving transistor Tr2. The connection of the reference voltage line and the data line 7 may be switched as separate wiring. Although a P-type transistor (PMOS) is used as the driving transistor Tr2 in FIG. 2, an N-type transistor (NMOS) may be used. Although the NMOSs are used as the transistors Tr1 and Tr3, the PMOSs may be used. Thin film transistors (TFT) are suitably used as the driving transistor Tr2 and the transistors Tr1 and Tr3.

Although the transistor Tr1 is a switching unit that connects the drain and the gate of the driving transistor Tr2, the arrangement is not limited to this as long as the connection between the drain and the gate of the driving transistor Tr2 can be controlled. Even if the driving transistor Tr2 is an NMOS, the transistor Tr1 connects the drain and the gate of the driving transistor Tr2. Although the transistor Tr3 is a switching unit that connects the drain of the driving transistor Tr2 and an anode of the organic EL element, the arrangement is not limited to this as long as the connection between the drain of the driving transistor Tr2 and the anode of the organic EL element can be controlled.

Although the control lines 5 and 6 control operations of the transistors Tr1 and Tr3, the number of control lines is not limited to two as long as the operations of the two NMOS transistors can be controlled. The control line 5 that supplies a scan/auto-zero signal P1 is connected to the gate of the transistor Tr1, and the control line 6 that transmits a light emitting period control signal P2 is connected to the gate of the transistor Tr3.

One terminal of the storage capacitor C1 is connected to the data line 7 that supplies the data voltage Vdata, and the other terminal is connected to the gate of the driving transistor Tr2 and the source of the transistor Tr1. The anode of the organic EL element is connected to the source of the transistor Tr3, and the cathode of the organic EL element is connected to CGND wiring. The +VCC wiring is connected to the source of the driving transistor Tr2.

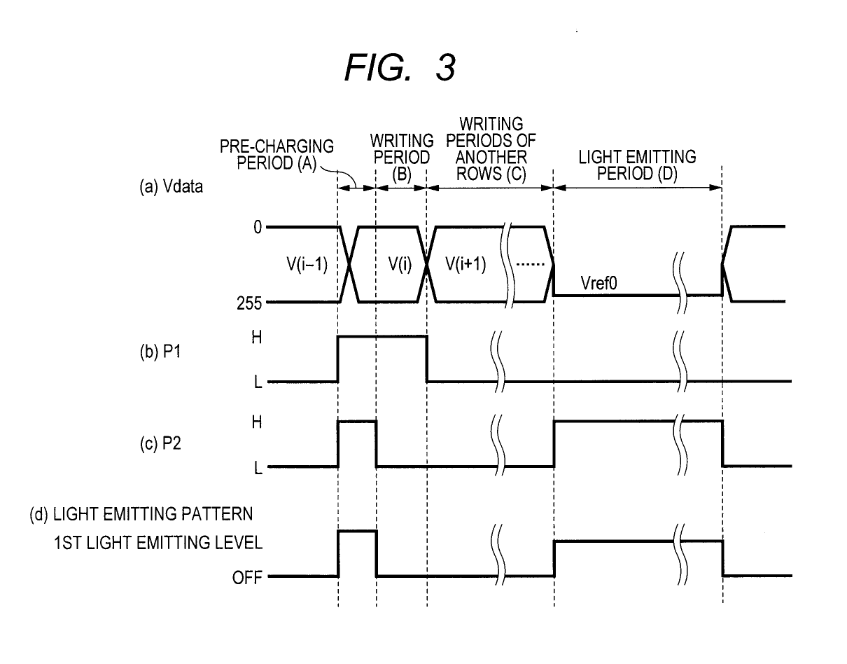

FIG. 3 is an example of a timing chart illustrating the driving method of the prior art of the pixel circuit of FIG. 2. FIG. 3 illustrates a voltage change of the data line 7, voltage changes of the control lines 5 and 6, and a light emitting pattern (light emitting state) of the light emitting element of an i-th row pixel with a common time axis. The present driving method is a driving method for operating one frame period by dividing the frame period into four periods: (A) pre-charging period, (B) writing period, (C) writing periods of other rows, and (D) light emitting period.

In FIG. 3, a threshold of the driving transistor Tr2 in the pixel circuit is cancelled in the periods (A) and (B). At the same time, a data voltage V(i) is written to the pixel and held by the storage capacitor C1. Although a current flows through the organic EL element to cause momentary light emission regardless of the data voltage during a pre-charging operation in the period (A), the light emission does not affect the gradation display. In the period (C), the thresholds are similarly cancelled in the pixels of the rows following the present row (i-th row), and at the same time, the data voltage is written. Subsequently, in the period (D), the voltage of VSL is applied to the data line 7, and a current according to the data voltage held by the storage capacitors C1 of the pixel circuits and according to the current driving ability of the driving transistor Tr2 is simultaneously supplied to the organic EL elements in all rows.

In this way, a constant current corresponding to the gradation data programmed according to the current driving ability of the driving transistor Tr2 is supplied to the organic EL element during the period (D) in one frame period. As in the light emitting pattern of FIG. 3, the organic EL element continues emitting light at constant luminance in the one frame period.

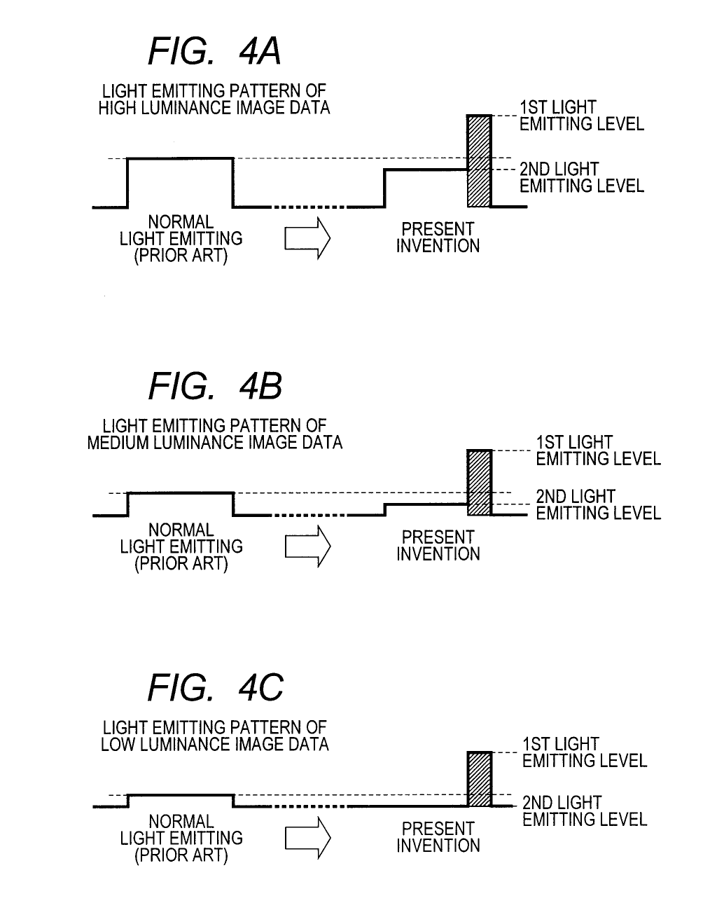

FIGS. 4A to 4C are diagrams illustrating light emitting patterns according to the image data, and examples of light emitting patterns of the prior art and light emitting patterns of the display apparatus of the present invention are illustrated side by side. The vertical axis denotes light emitting levels. A higher part denotes a light emitting state, and the lowest part denotes a non-light emitting state. In the light emitting patterns of the prior art, the height of the light emitting pulses, i.e. light emitting level, is determined by gradation display data supplied to the pixels. The horizontal axis denotes time, and the pulse width denotes the time of actual light emission of the pixel in the period of displaying one image. In the following description of the present invention, an average luminance (average light emitting level) is a value obtained by averaging light emitting quantities (cumulative light emitting quantities) of one pixel in one frame period within one frame. The meaning of the light emitting level and the meaning of the luminance are the same.

FIG. 4A illustrates a light emitting pattern of a pixel in the case of high luminance image data. Compared to the light emitting pattern of the prior art for emitting light at constant luminance in a constant period, light is emitted at two different kinds of luminance to obtain the same average luminance as in the light emitting pattern of the prior art, i.e. the same light emitting quantity in one frame.

In FIG. 4A, a sum of the light emitting period at a first light emitting level and the light emitting period at a second light emitting level is the same as the light emitting period of the light emitting pattern of the prior art. Therefore, there is a certain period for emitting light at the first light emitting level with higher luminance than the prior art (hereinafter, the light emission of the period may be called “dummy pulse”). In return, the luminance of the rest of the light emitting period is reduced, and the light is emitted at the second light emitting level.

FIG. 4B illustrates a light emitting pattern of a pixel in the case of medium luminance image data. As in the case of the high luminance image data, the light is emitted at two different kinds of light emitting levels to obtain the same average luminance (light emitting quantity) as in the light emitting pattern of the prior art.

In FIG. 4B, the sum of the light emitting period at the first light emitting level and the light emitting period at the second light emitting level is also the same as the light emitting period of the light emitting pattern of the prior art. Therefore, there is a certain period for emitting the light at the first light emitting level with higher luminance than in the prior art. In return, the luminance of the rest of the light emitting period is reduced, and the light is emitted at the second light emitting level. The light emitting levels of the first light emitting level and the second light emitting level are reduced compared to when the high luminance image data is written.

FIG. 4C illustrates a light emitting pattern of a pixel in the case of low luminance image data. As in the case of the high luminance image data, the light is emitted at two different kinds of light emitting levels to obtain the same average luminance (light emitting quantity) as in the light emitting pattern of the prior art.

In FIG. 4C, the sum of the light emitting period at the first light emitting level and the light emitting period at the second light emitting level is also the same as the light emitting period of the light emitting pattern of the prior art. Therefore, there is a certain period for emitting the light at the first light emitting level with higher luminance than in the prior art. In return, the luminance of the rest of the light emitting period is reduced. In this case, the second light emitting level may be about the same level as a black display which is almost a non-light emitting state.

The first light emitting level and the second light emitting level are switched based on the reference voltage (emitting luminance control signal), and there is no need to write two kinds of data voltages in the pixels. A first voltage is supplied as the reference voltage from the reference voltage line in the light emission at the first light emitting level, and a second voltage is supplied as the reference voltage from the reference voltage line in the light emission at the second light emitting level. The sum of the light emitting quantity of the light emitting element during the period of supplying the first voltage and the light emitting quantity of the organic EL element during the period of supplying the second voltage is controlled to be equal to the light emitting quantity of the organic EL element determined in advance according to the image data (in FIGS. 4A to 4C, the light emitting quantity in the light emitting pattern of the prior art).

The timing of the light emission at the first light emitting level does not have to be at the end of the light emitting period. The timing may be at the beginning or in the middle. However, during the light emission at the second light emitting level, the timing can be during the light emission at the second light emitting level or can be continuous with the light emission at the second light emitting level. This is because the levels are switched only by a change in the reference voltage for controlling the light emitting level.

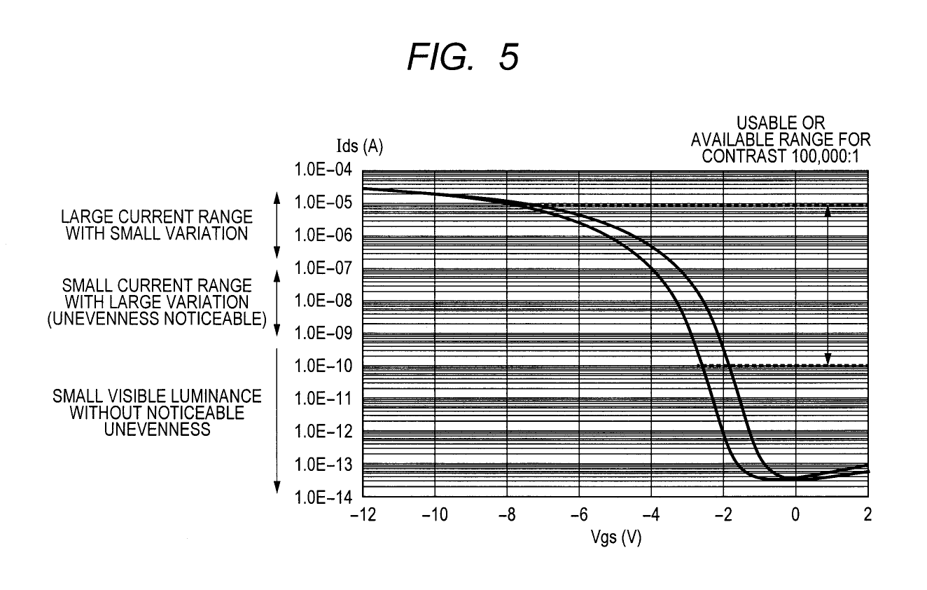

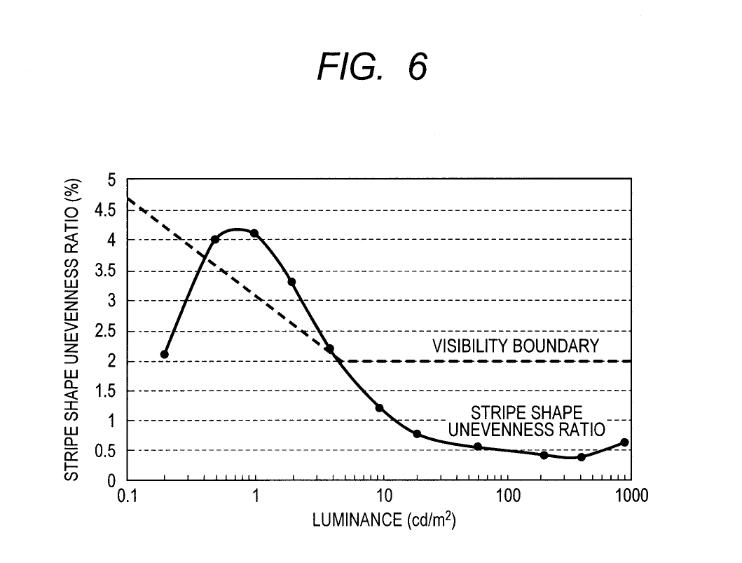

An appearance of luminance unevenness of display and variations in Tr characteristics that cause the luminance unevenness will be described with reference to FIGS. 5 and 6.

FIG. 5 illustrates a graph of Vg-Id characteristics of a general PMOS transistor. Vg-Id curves of two kinds of transistors with different characteristics (Vth and μ) are depicted in the graph. This indicates that there are variations in the transistor characteristics. The horizontal axis indicates a gate-source voltage (Vg), and the vertical axis indicates a drain current (Id).

The value of the drain current can be adjusted by designing the size of the transistor. The range of the drain current used in the display apparatus is determined by the luminance and the contrast of the designed display apparatus and by the light emitting efficiency of the light emitting elements. It is assumed here that the current ratio as the contrast is 100,000 to 1, and black to white of the image is expressed based on a usable range of 100 pA to 10 μA as a current range that can be easily controlled by the gate voltage.

When the difference between the two kinds of Vg-Id curves of FIG. 5 is focused in the usable range, the ratio of the current difference relative to the drain current is small in a range with a large current (100 nA to 10 μA) when the same Vg is applied. On the other hand, the ratio of the current difference relative to the drain current is large in a range with a small current (1 nA to 100 nA) when the same Vg is applied.

Although the ratio of the current difference relative to the drain current is large in a range with a smaller current (up to 1 nA) when the same Vg is applied, the absolute value of the current is significantly small, and the current difference is a small value. If the small current is used in the display apparatus, the amount of current flowing into the light emitting element is small, and the display is almost black. Both are recognized as black displays even if there is a luminance difference caused by the current difference, and the displays are scarcely observed. Even if the used current range is a little different, the ratio of the current difference is relatively small in the range with a large current relative to the range with a small current.

Meanwhile, FIG. 6 illustrates a graph of a stripe shape unevenness (luminance unevenness) ratio indicating a ratio of a difference between the luminance of the display apparatus and the luminance of a luminance unevenness part with the brightness. The luminance unevenness ratio of FIG. 6 is an example of stripe-shaped luminance unevenness (stripe shape unevenness) characteristics of the display apparatus using a TFT created in a general LIPS process. The stripe shape unevenness ratio (stripe-shaped luminance unevenness ratio) is expressed by

Stripe shape unevenness ratio=|{(luminance of stripe shape unevenness pixel)−(average luminance of pixels around stripe shape unevenness pixel)}|/(average luminance of pixels around stripe shape unevenness pixel)}

Average luminance of pixels around stripe shape unevenness pixel=average luminance of five pixels on the left and five pixels on the right of the stripe shape unevenness pixel.

The stripe shape unevenness pixel denotes a pixel that displays different luminance by visual observation compared to surrounding pixels when the same voltage data is written in all pixels for light emission.

As can be seen from FIG. 6, the stripe shape unevenness ratio is low in a range with high luminance, and the stripe shape unevenness ratio is high in a range with low luminance. The stripe shape unevenness ratio is caused by variations in the PMOS transistor characteristics in the pixel circuit. Therefore, as shown in FIG. 5, the stripe shape unevenness ratio is low in a range with a large amount of current and with a small current difference in the PMOS transistor, i.e. in a range with high luminance in FIG. 6.

On the other hand, the stripe shape unevenness ratio is high in a range with a small amount of current and with a large current difference in the PMOS transistor, i.e. in a range with small luminance in FIG. 6. In a range with significantly low luminance (0.5 cd/m² or below), the reference brightness is low and is near the measurement limit. Therefore, the stripe shape unevenness ratio is low by the appearance.

A visibility boundary of general stripe shape unevenness is also illustrated. If the luminance is high on some level, for example, 5 cd/m² or more, it is stated that the stripe shape unevenness is observed when the stripe shape unevenness is 2% or more. If the luminance is low, the minimum stripe shape unevenness ratio that can be observed is high due to the visual characteristics of human being. For example, it is stated that the stripe shape unevenness is observed around 1 cd/m² when the stripe shape unevenness is 3% or more. The stripe shape unevenness ratio characteristics of FIG. 6 indicate an example in which the stripe shape unevenness is observed around 0.5 to 5 cd/m².

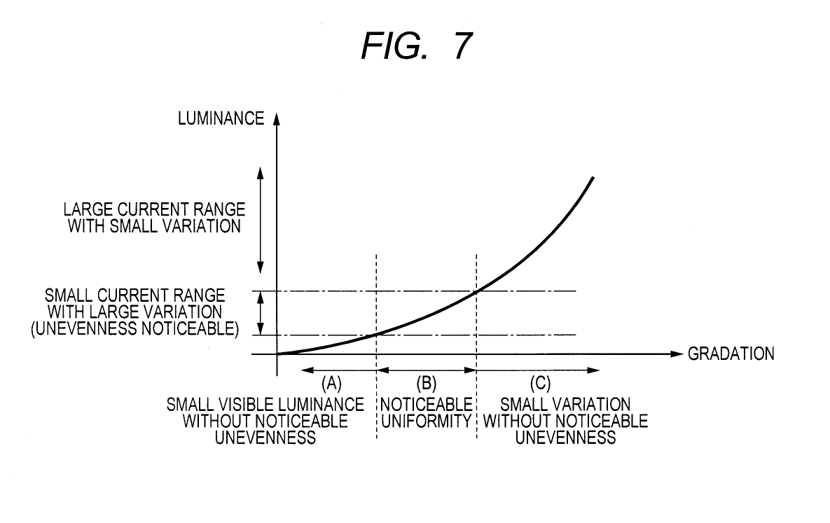

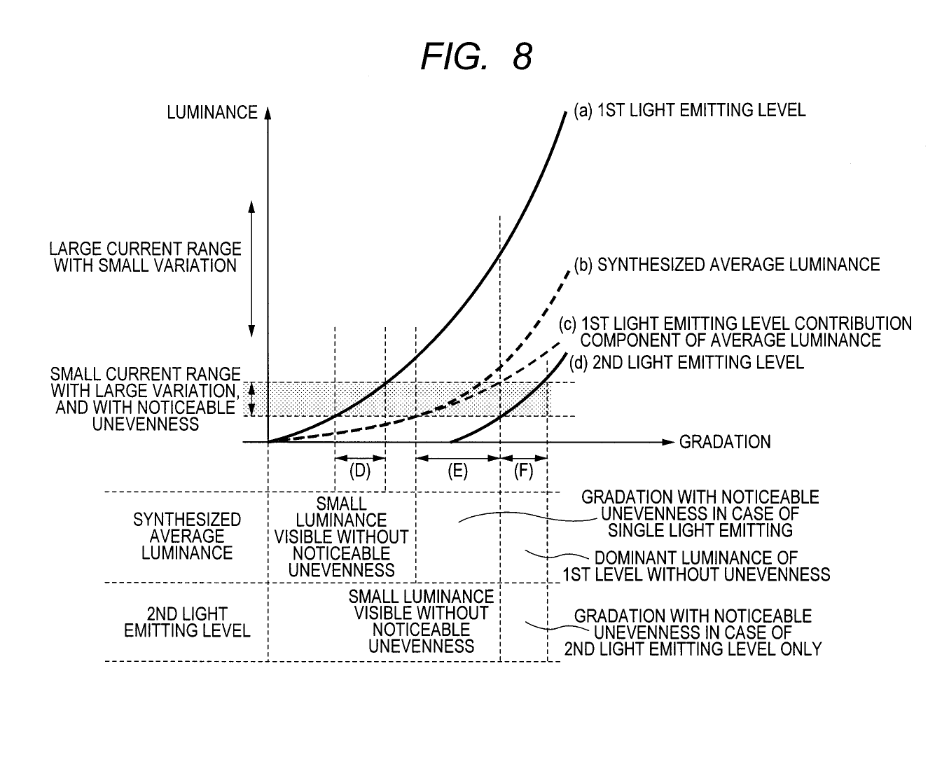

A mechanism of suppressing the luminance unevenness by emitting light at two kinds of light emitting levels will be described with reference to FIGS. 7 and 8.

FIG. 7 is a graph illustrating gradation characteristics of luminance unevenness of the image display unit that is visible when all pixels are displayed based on the same data voltage at a single light emitting level as in the prior art after cancelling some of the threshold variations of the TFT. The horizontal axis denotes gradation, and the vertical axis denotes luminance. If the characteristics are replaced by the transistor characteristics, the horizontal axis can be assumed as gate voltage, and the vertical axis can be assumed as drain current. A curve in the graph is one of the transistor characteristics.

Current variations of the transistor characteristics will be considered here. In a range with a large current, the rate of the current variations of the transistor is relatively small because the average current of the current variations is large. On the other hand, in a range with a small current, although the absolute value of the current variations is small, the average current is also small. As a result, the rate of the variations tends to be large.

The visibility of the luminance unevenness of the display apparatus will be considered using the transistor. The luminance of the self-light-emitting element such as the organic EL element is substantially proportional to the flowing current. Therefore, the size of the luminance unevenness is substantially proportional to the variations in the amount of current. In a high gradation range of the data voltage, i.e. the range (C) with a large amount of current flowing through the pixels, the rate of the current variations is small, and the luminance unevenness is not easily observed in the display apparatus.

In a medium gradation range of the data voltage with a little lower luminance than in the range (C), i.e. the range (B) with a little smaller amount of current flowing through the pixels, the rate of the variations in the current is large, and the luminance unevenness is easily observed in the display apparatus.

In a low gradation range of the data voltage with further lower luminance than in the range (B), i.e. the range (A) with a significantly small amount of current flowing through the pixels, although there are variations in the current, the absolute value of the current is significantly small. As a result, the luminance is significantly low, and the absolute amount of the luminance difference caused by the variations is small. The luminance unevenness is not easily observed.

FIG. 8 is a diagram describing a relationship between the gradation, the average luminance, and the appearance of the luminance unevenness when all pixels emit light at two kinds of light emitting levels based on the same data voltage. The luminance unevenness is observed with the gradation when a curve indicating the light emitting level is within a range of luminance in which the current is small and the variations are noticeable (hatched area). Compared to the second light emitting level, the luminance is higher and the light emitting period is shorter in the first light emitting level. The two light emitting levels denote momentarily lighted luminance. In other words, the luminance is the same as average luminance of light emissions with 100% light emitting duty at the light emitting levels.

In the display apparatus, the luminance obtained by averaging (synthesizing) the sums of the light emitting quantities of the first light emitting level and the second light emitting level in one frame time is the visually observed average luminance, which is illustrated by a dotted curve (b) of FIG. 8. Light emitting quantity components of the first light emitting level are also illustrated by a dotted curve (c) of FIG. 8. The prior art indicates the dotted curve (b) of FIG. 8 in the single light emission.

In the range with the lowest gradation, i.e. in the gradation range lower than (D) of FIG. 8, the second light emitting level indicates black, and the gradation is displayed only by a short-time light emission at the first light emitting level. Moreover, the luminance of the first light emitting level is a significantly low luminance of (A) of FIG. 7 level, and the luminance unevenness is not easily observed.

In the gradation range of (D) of FIG. 8, the second light emitting level indicates black, and the gradation is displayed only by a short-time light emission at the first light emitting level. Although the luminance at the first light emitting level is emitted at luminance with which the luminance unevenness of (B) of FIG. 7 level is visible, the first light emitting level is a short time, and the observed luminance is the synthesized luminance depicted by the dotted curve (b). As a result, the luminance is significantly low, and the luminance unevenness is not easily observed.

In a gradation range between (D) and (E) of FIG. 8, the light emission with luminance at the first light emitting level is light emission at luminance with little luminance unevenness of (C) of FIG. 7 level as in the curve (a), and moreover, the observed luminance is synthesized luminance depicted by the dotted curve (b). As a result, the luminance unevenness is small, and the luminance is significantly small. The luminance unevenness is not observed.

A gradation range of (E) of FIG. 8 is an area where the unevenness is noticeable in the display by the single light emission. However, the light emission with luminance at the first light emitting level as in the curve (a) is light emission at high luminance in which the luminance unevenness of (C) of FIG. 7 level is not easily observed. In the second light emitting level, the luminance is also significantly low luminance of (A) of FIG. 7 level as illustrated in the curve (d), and the luminance unevenness is not easily observed. The two light emissions, in which the luminance unevenness is not easily observed, are synthesized. Therefore, the luminance unevenness is not easily observed with the synthesized luminance.

In a gradation range of (F) of FIG. 8, the light emission with luminance at the first light emitting level is light emission at high luminance in which the luminance unevenness of (C) of FIG. 7 level is not easily observed. The second light emitting level is emitted with luminance in which the luminance unevenness of (B) of FIG. 7 level is visible. In the synthesized luminance, although there is luminance unevenness caused by the second light emitting level, the luminance is synthesized with light emission in which the luminance unevenness at the first light emitting level is not easily observed. This reduces the rate of the luminance unevenness. As a result, the luminance unevenness is not easily observed in the synthesized luminance.

In a gradation range higher than (F) of FIG. 8, the light emission with luminance at the first light emitting level is light emission at high luminance in which the luminance unevenness of (C) of FIG. 7 level is not easily observed. The light emission at the second light emitting level is also light emission with luminance in which the luminance unevenness of (C) of FIG. 7 level is not easily observed. Since the two light emissions in which the luminance unevenness is not easily observed are synthesized, the luminance unevenness is not easily observed with the synthesized luminance.

In this way, even in the drive including a gradation with noticeable luminance unevenness at the single light emitting level, the luminance unevenness can be reduced in all gradation ranges by causing the pixels to emit light at two kinds of light emitting levels. More specifically, the luminance unevenness can be more effectively suppressed by causing the pixels to emit light at two kinds of luminance levels and using ranges with small current variations of transistor or ranges without noticeable current variations to display the gradation, without using ranges with large current variations of transistor.

As a result of the light emission of the pixels at two kinds of light emitting levels, the light emitting period may be short with only the first light emitting level, and the brightness of the synthesized luminance may be insufficient. Or the first light emitting level may be too large. To compensate this, the light emission at the second light emitting level can be added to obtain desired synthesized luminance.

With an example in which the driving transistor is a PMOS, an upper limit of the first light emitting level will be described using a first voltage as a reference voltage in the light emission at the first light emitting level and a second voltage as a reference voltage in the light emission at the second light emitting level.

Values need to be set for the first voltage and the second voltage so that the voltages do not depend on the data voltage written to the pixels, and the gradation from “white” to “black” can be displayed at an average light emitting level of the first light emitting level and the second light emitting level. The relationship between the data voltage and the luminance is predetermined based on the characteristics of the display. Therefore, the low gradation leads to blocked up shadows if the first voltage is too high, and black becomes dull if the first voltage is too low. Thus, the first voltage is set within a range satisfying the conditions, and a light emitting level for light emission based on a difference between the first voltage and a white gradation data voltage is the upper limit of the first light emitting level.

The gradation at the boundary of the gradation range of (E) of FIG. 8 and the gradation range of (F) of FIG. 8 will be further described in detail. The second light emitting level is set in the gradation.

The gradation is the lowest gradation in the ranges with noticeable stripe shape unevenness when the pixels are displayed by light emission with only the second light emitting level. If the gradation is higher, the gradation is switched to the range (F) with a noticeable stripe shape as a result of the light emission of only the second light emitting level. In this case, the average luminance increases by adding the light emission at the first light emitting level, and the rate of the stripe shape unevenness components is reduced compared to the light emission with only the second light emitting level. Therefore, the stripe shape unevenness can be made unnoticeable. The light emitting quantity of the first light emitting level added at this point is a light emitting quantity that makes the stripe shape unevenness unnoticeable in the emission at 100% light emitting duty with only the first light emitting level.

In the display of the gradation, the light emitting quantity at the first light emitting level is a light emitting quantity of boundary without noticeable stripe shape unevenness even if the light emitting duty is set to 100% to set the luminance level that allows obtaining the same light emitting quantity as the light emitting quantity at the first light emitting level. However, actually, the light emitting period is shortened to set the same amount of light emission in the first light emitting level, and the light emitting level is higher than when the light emitting duty is set to 100%. As a result, the light emission is at a gradation with enough margin for making the stripe shape unevenness unnoticeable. Since the second light emitting level is added there, the stripe shape unevenness components caused by the second light emitting level are not visually observed.

More specifically, if a gradation greater than the luminance that makes the stripe shape unevenness sufficiently unnoticeable is displayed just by the first light emitting level, light emission without noticeable stripe shape unevenness is possible in one frame even if the second light emitting level is at luminance with noticeable stripe shape unevenness. On the other hand, if a gradation smaller than luminance that makes the stripe shape unevenness sufficiently unnoticeable just by the first light emitting level, the second light emitting level needs to be set at luminance that makes the stripe shape unevenness unnoticeable. This will be called a first condition.

For a second condition, it is better that the difference between the second light emitting level and the first light emitting level is small. This is because the luminance at the first light emitting level can be suppressed. Therefore, the second light emitting level is set higher as much as possible. However, the smaller the difference between the second light emitting level and the first light emitting level, the lower the suppression effect of the stripe shape unevenness. Therefore, some difference needs to be left between the second light emitting level and the first light emitting level. Specifically, the second light emitting level is set to a lower limit of the luminance of the range with noticeable unevenness just by the second light emitting level.

The second voltage is determined such that the second light emitting level satisfies both the first condition and the second condition.

Hereinafter, exemplary embodiments of a display apparatus and a driving method of the display apparatus of the present invention will be illustrated.

### First Embodiment

The display apparatus of the present embodiment is the display apparatus of FIG. 1, and the pixel circuit is the pixel circuit of FIG. 2.

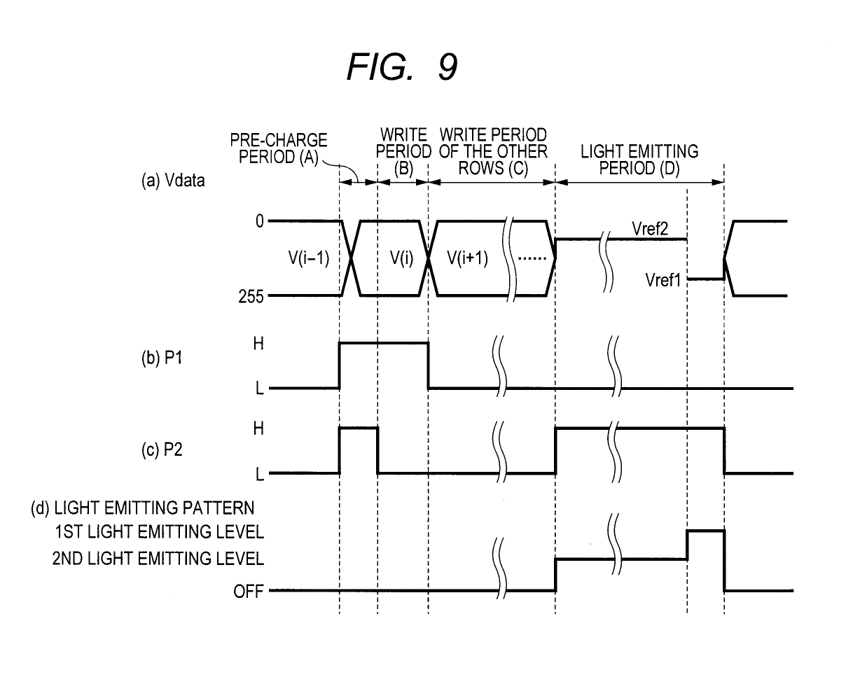

FIG. 9 is an example of a timing chart illustrating an operation of the pixel circuit of FIG. 2 according to the present embodiment. FIG. 9 illustrates a voltage change of the data line 7, voltage changes of the control lines 5 and 6, and a light emitting pattern (light emitting state) with a common time axis. One frame period is divided into the following four periods of (A) to (D) in the operation of the present embodiment.

(A) Pre-Charging Period

In the period, the transistor Tr1 and the transistor Tr3 are set to “on” to set the driving transistor Tr2 to “on” by lowering the gate voltage. The data line 7 is set to the data voltage Vdata (V(i)), and the data voltage is applied to the data line 7 of the storage capacitor C1. The following is a specific operation.

If the control lines 5 and 6 are set to “High”, the transistor Tr1 and the transistor Tr3 are changed to “on”. The transistor Tr1 connects the drain and the gate of the driving transistor Tr2, and a diode connection state is temporarily set. More specifically, the driving transistor Tr2 enters an “on” state. The data line 7 is set to the data voltage Vdata (V(i)).

(B) Writing Period

In the period, the transistor Tr3 is set to “off” to set the threshold voltage to the gate of the driving transistor Tr2. The storage capacitor C1 holds a voltage of a difference between the gate voltage of the driving transistor Tr2 and the data voltage applied to the electrode of the data line 7 of the storage capacitor C1. The following is a specific operation.

The control line 6 is set to “Low”, and the transistor Tr3 is set to “off”. After a short time, the storage capacitor C1 stores the voltage (auto-zero voltage) of the difference between the data voltage and the gate voltage (threshold voltage) of the driving transistor Tr2. The gate voltage, more accurately, Vgs (gate-source voltage) of the driving transistor Tr2, is set to the threshold voltage of the driving transistor Tr2. As a result of the operation, a predetermined driving current according to the data voltage can be supplied to the light emitting element regardless of the threshold voltage change of the driving transistor Tr2 or the threshold voltage variations.

(C) Writing Periods of Other Rows

In the period, the voltage difference held by the storage capacitor C1 is maintained even if the voltage of the data line 7 is changed to a data voltage of other rows by setting the transistor Tr1 to “off”. The following is a specific operation.

The control line 5 is set to “Low”, and the sampling period of the program target row (i-th row) is finished. The data line 7 then switches to the data voltage (V(i+1)) of the next row (i+1-th row), and the program of the next row (i+1-th row) is quickly started. In this case, the voltage difference held by the storage capacitor C1 is held, because there is no movement in the electric charge in the driving transistor Tr2.

(D) Light Emitting Period

In the period, the voltage difference between both terminals of the storage capacitor C1 is maintained, and the gate voltage of the driving transistor Tr2 is set to a desired voltage by setting the voltage of the data line 7 to the reference voltage Vref. A voltage according to the driving voltage of the driving transistor Tr2 is supplied to the organic EL element by setting the transistor Tr3 to “on”. In this case, a light emitting intensity control unit changes the reference voltage Vref within the light emitting period to emit light at two kinds of light emitting levels, the first light emitting level and the second light emitting level, in the light emitting period (D) to suppress the luminance unevenness. The following is a specific operation.

The voltage of the data line 7 is changed from the data voltage V(n) of the final row to Vref2. Since the voltage difference between both terminals of the storage capacitor C1 is maintained, a voltage for desired gradation display according to the voltage written by the gate voltage of the driving transistor Tr2 in the writing period is set.

The control line 6 is set to “High”, and the transistor Tr3 is set to “on”. Therefore, the current supplied by the driving transistor Tr2 flows through the organic EL element. Thus, the driving transistor Tr2 functions as a constant current source.

The voltage Vdata of the data line 7 is set to Vref2 in the first half of the light emitting period (D). Specifically, Vref2 is set such that the gate voltage of the driving transistor Tr2 is a little higher than the gate voltage for the desired gradation display, i.e. the current is a little smaller. As a result, the organic EL element emits light at the second light emitting level.

The data line voltage Vdata is set to Vref1 in the second half of the light emitting period (D). As a result, the organic EL element emits light at the first light emitting level that is different from the second light emitting level. Since the luminance of the second light emitting level has been set a little low, the luminance of the first light emitting level is set larger than the luminance of the second light emitting level.

In this way, the luminance unevenness can be suppressed in the present embodiment. The mechanism for suppressing the luminance unevenness is already described, and the description will not be repeated.

The voltage of the data line is changed to change the light emitting level within one frame period in the present embodiment. Meanwhile, there can be a method of changing the light emitting level by changing the voltage of the power line. However, the amount of flowing current in the power line is usually greater than that in the data line, and wiring is wider to reduce the resistance. As a result, the parasitic capacitor of the power wiring is large. The voltage is more frequently changed in the data line compared to other wiring, and the wiring capacitor is designed small. Therefore, the power consumption is smaller in changing the voltage of the data line than in changing the voltage of the power line.

In this way, the control circuit performs the following (1) and (2) controls in the present embodiment.

(1) The data voltage is supplied to the pixels through the data line in one frame period, and the data voltage is written in the storage capacitor. Predetermined first voltage Vref1 and second voltage Vref2 that are different from each other are successively supplied to the reference voltage line in this order or reversed order.

(2) In each pixel, the sum of the light emitting quantity of the organic EL element during the period of supplying the first voltage and the light emitting quantity of the organic EL element during the period of supplying the second voltage is controlled to be equal to a predetermined light emitting quantity of the organic EL element according to the image data.

Even if the control circuit as in the present embodiment is not included, the configuration is not limited to the one described in the present specification as long as the functions of the control circuit are included. For example, part of the functions of the control circuit can be incorporated into the driver IC, and the output of the driver IC can be directly connected to the pixels. In this way, advantages of the present invention can be attained by carrying out the drives of (1) and (2) by a plurality of data lines and a plurality of reference voltage lines arranged on the organic EL display apparatus in each frame period.

The timing of setting the voltage of the data line 7 to Vref1 can be any time during the light emitting period. The following is a method of setting the second light emitting level that is the luminance of the first half of the light emitting period to luminance a little lower than the luminance in the light emission at a constant level for a desired gradation display. Instead of setting the voltage of Vref2 a little higher, the voltage can be written in the pixels by executing a calculation process in advance such that the current of the data voltage Vdata is a little smaller.

Vref1 and Vref2 are input to the pixels through the data line, and both or one of Vref1 and Vref2 may be changed depending on the light emitting color of the pixels. In the display, the difference between the first light emitting level and the second light emitting level varies depending on the light emitting color. As a result, the white balance can be optimally adjusted, and the intensity of the dummy pulse can be changed.

For example, in relation to blue light emission in which the luminance unevenness is not easily observed, the luminance unevenness may not be observed even if the dummy pulse is small or the dummy pulse is not input. In such a case, the size of the dummy pulse can be changed for the blue pixels relative to other light emitting colors. This is because the power consumption may increase if the luminance of the dummy pulse is too high.

If the voltages of the gate electrode of the driving transistor Tr2 after the supply of the first voltage and after the supply of the second voltage are designated with Va1 and va2, respectively, the control circuit can control the first voltage and the second voltage such that va1 and va2 are set to the following voltages.

One of Va1 and Va2 is greater than the voltage of the gate electrode when the voltage is applied to obtain the predetermined light emitting quantity of the organic EL element according to the image data by causing the pixels to emit light at a constant light emitting level in one frame period after writing the data voltage in the storage capacitor C1. The other of Va1 and Va2 is smaller than the voltage of the gate electrode when the voltage is applied to obtain the predetermined light emitting quantity of the organic EL element according to the image data by causing the pixels to emit light at a constant light emitting level in one frame period after writing the data voltage in the storage capacitor C1. This can be applied to second to fifth embodiments described below.

Since the luminance is different in each light emitting color, the light emitting level of the organic EL element during the period of supplying the first voltage and the light emitting level of the organic EL element during the period of supplying the second voltage can be different in each light emitting color.

As described, according to the present embodiment, the light emission based on a large current with small variations and the light emission at low luminance with which the luminance unevenness is not easily observed can be used by displaying the gradation based on the light emission at two kinds of light emitting levels, and the luminance unevenness can be suppressed.

### Second Embodiment

The overall configuration of the display apparatus of the present embodiment is almost the same as in the first embodiment. Differences from the first embodiment are that an image data determination unit is included, and the image data determination unit changes the light emitting method in the light emitting period (D). The pixel circuit of the display apparatus of the present embodiment is the same as in the first embodiment.

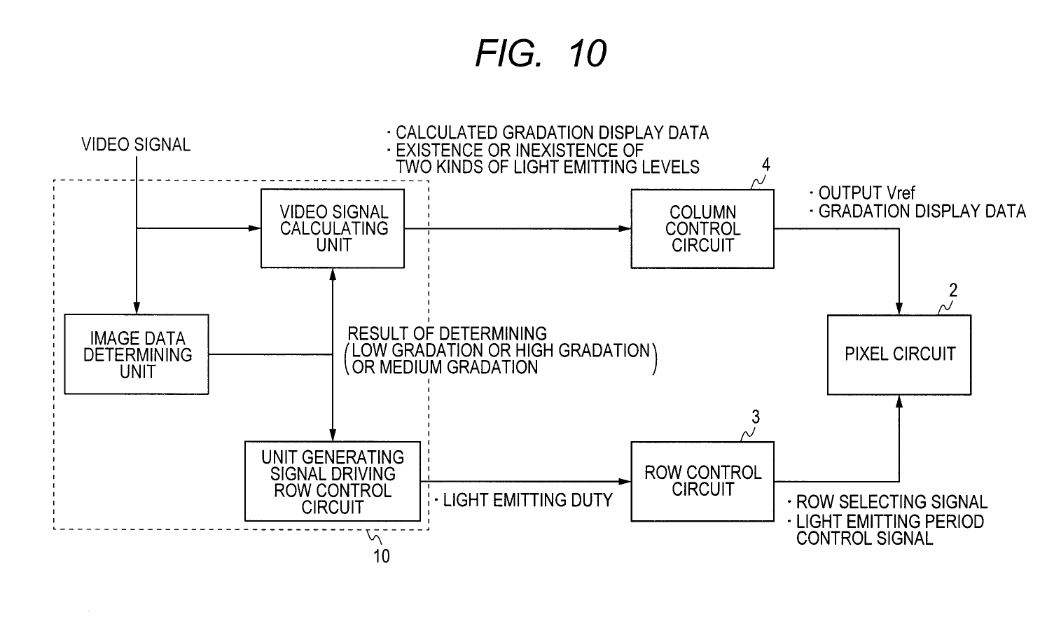

FIG. 10 illustrates an example of a flow of video data (image data) input to the display apparatus through the image data determination unit.

When image data is input to the display apparatus, the image data determination unit determines, for each frame, whether the image data is high luminance image data (high luminance mode) or low luminance image data (low luminance mode) based on average luminance of image data of one frame. The criteria can be arbitrarily set based on the amount of data or the amount of current for display. When the amount of current for display is the criteria, image data with half the current of full-pixel white display in which the driving current flowing through the display apparatus is the maximum can be set as a threshold, and the image data can be determined as the high luminance image data if the image data causes light emission by applying a driving current greater than the threshold to the display apparatus in one frame period.

If the image is a high-luminance image based on the result of the determination, the column control circuit 4 inputs two kinds of Vref signals to the data line 7 in the light emitting period to allow light emission of the dummy pulse. At the same time, a video data calculating unit creates image data for writing with reduced luminance equivalent to the light emitting quantity of the dummy pulse and inputs the data to the column control circuit 4. If the dummy pulse is added without converting the image data to the image data for writing, the light emitting quantity becomes greater than the light emitting quantity of the original data by the amount of the light emitting quantity of the dummy pulse. To offset the increase in the light emitting quantity, the luminance level of the image data for writing is reduced in advance. Instead of reducing the luminance level by converting the image data to the image data for writing, the Vref2 voltage can be adjusted to reduce the second light emitting level to offset the increase in the light emitting quantity of the dummy pulse. On the other hand, if the image is a low-luminance image, the column control circuit 4 or the row control circuit 3 inputs a signal for reducing the light emitting duty to 1/X times to the data line 7 or the control line 6. For example, if the white (maximum luminance) level is 1, and the maximum luminance level of the luminance range in which the image data determination unit determines that the average luminance of the image data is low luminance is A, 1/A=X is formed. A natural number, such as 2 or 4, that facilitates the calculation is set to X in advance.

Specifically, to reduce the light emitting duty to 1/X times in the data line 7, Vref2 is set to a substantially non-light emitting level, and 1/X of the entire period is set to Vref1. To reduce the light emitting duty to 1/X times in the control line 6, the High period of the control line 6 of FIG. 2, i.e. the period in which the transistor Tr3 of FIG. 2 is ON, is set to 1/X of the entire period. At the same time, the video data calculating unit creates image data for writing to increase the luminance to X times and inputs the data to the column control circuit 4 to maintain the luminance before the reduction of the light emitting duty.

The voltage data output from the column control circuit 4 is input to the pixel circuit 2 through the data line 7. As a result, the pixels emit light at desired luminance.

The luminance of the image data may not be determined by the frame, and the luminance of the image data may be determined by the plurality of frames to reduce the calculations. One frame period may be divided into blocks, such as rows and columns, to determine the luminance to improve the image quality. When the data line 7 extending in the column direction is used to control the light emitting intensity as in the present embodiment, the minimum unit for determining the image data can be columns.

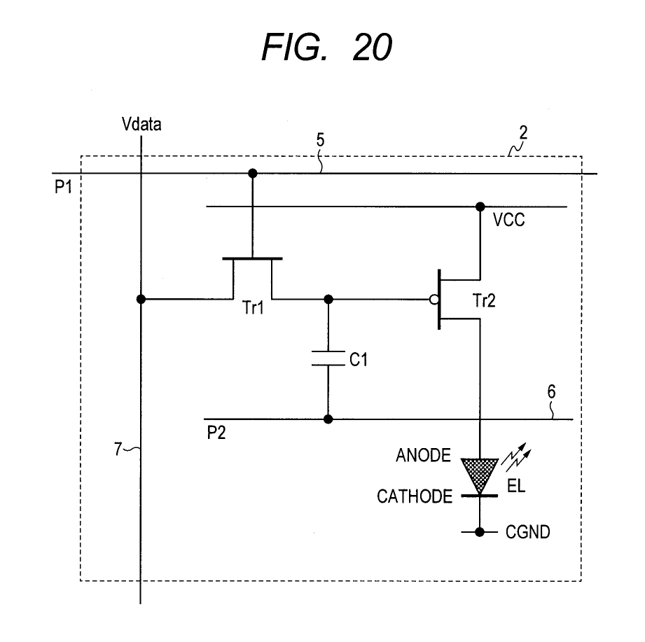

When the light emitting intensity is controlled by the control line 6 extending in the row direction (pixel circuit as in FIG. 20 as an example of the pixel circuit 2), the minimum unit for determining the image can be rows. The light emitting period control by the control line 6 extending in the row direction and the light emitting period control by the data line 7 extending in the column direction can be combined as in the present embodiment to divide the display area into blocks of rows and columns.

The image data may not be determined based on the average luminance of image data blocks. Whether the image data indicates a high-luminance image or a low-luminance image can be determined based on one of maximum luminance data and minimum luminance data of the image data blocks.

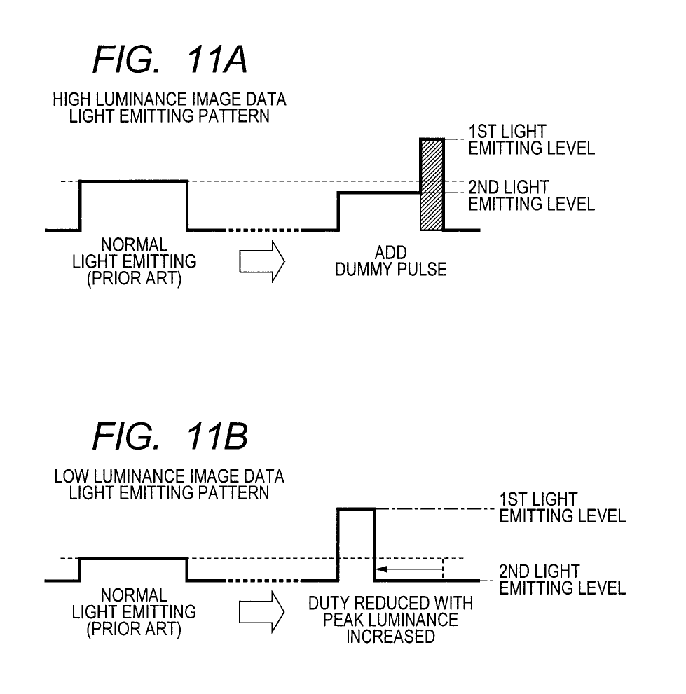

FIGS. 11A and 11B are diagrams illustrating an example of light emitting patterns according to image data of the display apparatus according to the present embodiment.

FIG. 11A illustrates a light emitting pattern for high luminance image data. Compared to the light emitting pattern of the prior art for emitting light at constant luminance for a constant period, the light is emitted at a plurality of different light emitting levels. Although the sum of the light emitting periods is the same in FIG. 11A to obtain the same luminance as the light emitting pattern of the prior art, there is a period (dummy pulse light emitting period) for emitting light at higher luminance than in the prior art for a certain period, and in return, the luminance in the rest of the light emitting period is reduced.

The timing for emitting light at high luminance may not be at the end of the light emitting period. The timing may be at the beginning or in the middle.

FIG. 11B illustrates a light emitting pattern for low luminance image data. Compared to the light emitting pattern of the prior art for emitting light at constant luminance for a constant period, the light emitting duty is reduced, and in return, the light is emitted at high luminance.

An operation of the pixel circuit of FIG. 2 according to the present embodiment will be described with reference to timing charts of FIGS. 9, 12, and 13. The periods other than the light emitting period (D) are the same as in the first embodiment, and the description will not be repeated.

In the present embodiment, the subsequent driving method changes depending on whether the image data determined by the image data determination unit is high luminance data or low luminance data. If the image data is high luminance data, the drive is exactly the same as the drive in the first embodiment, and the drive of FIG. 9 is performed.

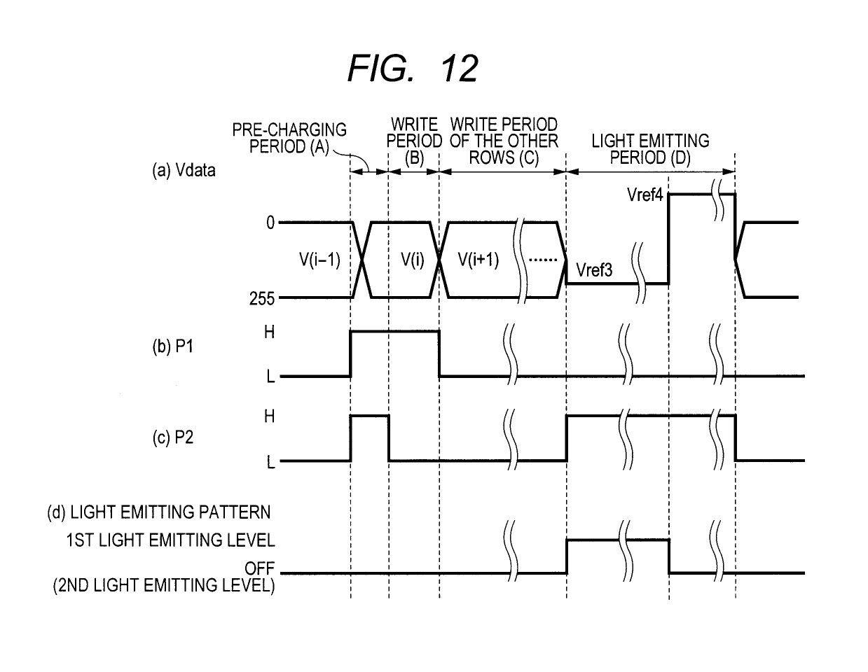

On the other hand, if the image data is low luminance data, the drive of FIG. 12 is performed. The light emitting period of the light emitting period (D) is reduced, and in return, the momentary luminance is increased to suppress the luminance unevenness while obtaining desired luminance. The following is a specific operation.

The light emitting duty is reduced to 1/X times in the light emitting period (D). In this regard, the voltage Vdata of the data lines 7 is set to Vref3 in the period of 1/X in the first half of the light emitting period (D). This is a voltage that sets the current supplied by the driving transistor Tr2 to the organic EL element X times as large as the current when Vdata is set to Vref0 of FIG. 3. As a result, the X times larger current flows through the organic EL element, and the organic EL element emits light at the first light emitting level with luminance X times as large as normal luminance.

In the rest of the light emitting period (D), the voltage Vdata of the data lines 7 is set to Vref4. Vref4 is a voltage that sets the driving transistor tr2 to an OFF state. As a result, the organic EL element enters a non-light emitting state. As a result, desired luminance can be obtained frame by frame. In this case, the luminance unevenness is suppressed.

The mechanism of suppressing the luminance unevenness will be described. If the second light emitting level is almost zero in FIG. 7, the synthesized luminance decreases. However, it is the same that the synthesized luminance can be set to low luminance without noticeable luminance unevenness by increasing the luminance of the first light emitting level relative to the synthesized luminance and limiting the light emissions in ranges with small current variations and in ranges with large current variations to light emissions of a short period. The effect of making the luminance unevenness unnoticeable is not eliminated even if the second light emitting level is almost zero.

The light emitting intensity can be increased to X times by reducing the light emitting duty to 1/X times. As a result, the first light emitting level can be used in a large current range with small variations in the display at low luminance, and the luminance unevenness can be excellently suppressed. If the light emitting intensity is increased to X times in the high luminance range, the momentary current flows excessively, and there is a problem that the driving voltage increases.

In this way, the control circuit performs the following (1) and (2) controls in the present embodiment.

(1) The data voltage is supplied to the pixels through the data line in one frame period, and the data voltage is written in the storage capacitor. The predetermined first voltage Vref3 and second voltage Vref4 that are different from each other are supplied to the reference voltage line in this order or reversed order in each determined luminance datum.

(2) In each pixel, the sum of the light emitting quantity of the organic EL element during the period of supplying the first voltage and the light emitting quantity of the organic EL element during the period of supplying the second voltage is controlled to be equal to a predetermined light emitting quantity of the organic EL element according to the image data.

Even if the control circuit as in the present embodiment is not included, the effect of the present invention can be attained by carrying out the drives of (1) and (2) in the plurality of data lines and the plurality of reference voltage lines arranged on the organic EL display apparatus for each frame period.

If the data is determined to be the low luminance data, the effect of the present invention can be further attained if the control circuit of the present embodiment performs the following (3) to (5) controls in addition to the (1) and (2) controls of the present embodiment.

(3) The light emitting level of the organic EL element during the period of supplying the first voltage Vref3 is controlled to be higher than the light emitting level of the organic EL element during the period of supplying the second voltage Vref4.

(4) The period of supplying the first voltage Vref3 is controlled to be 1/X times (X>1) the light emitting period determined in advance in the light emitting duty, and the organic EL element is controlled to emit no light during the period of supplying the second voltage Vref4.

(5) In each pixel, the light emitting quantity of the organic EL element during the period of supplying the first voltage Vref3 is controlled to be equal to the light emitting quantity of the organic EL element predetermined according to the image data.

The timing of setting the voltage of the data line 7 to Vref3 in the present embodiment can be any timing within the light emitting period. The following is a method of setting the first light emitting level, which is the luminance being emitted, X times as large as the luminance emitted at a constant level for desired gradation display. The voltage of Vref3 can be set to a voltage such that the current supplied to the organic EL element by the driving transistor Tr2 is set X times as large as when Vref0 of FIG. 3 is set, or a calculation process can be applied in advance to the image data to obtain image data for writing so as to increase the current by X times to write the data in the pixels while maintaining the voltage of Vref3 to a voltage similar to Vref0.

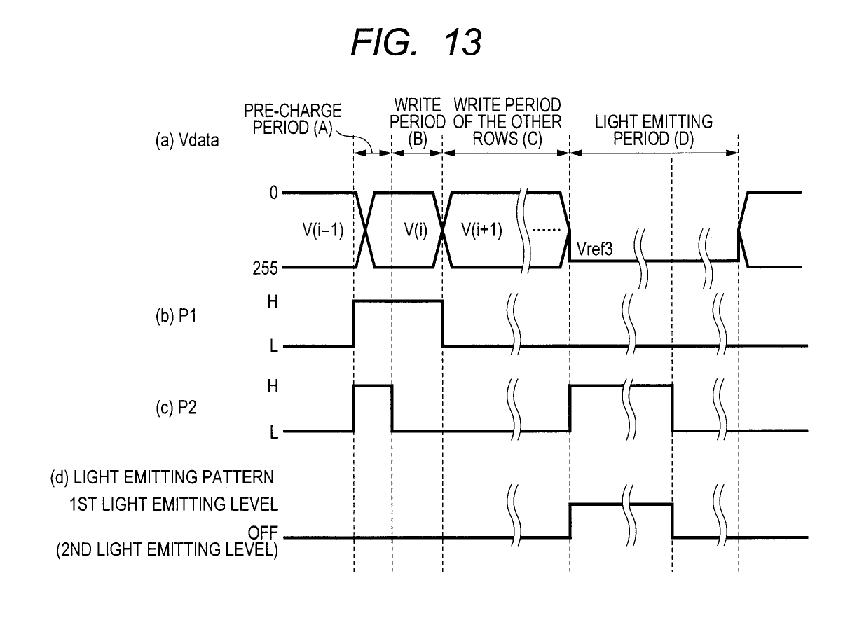

As in the drive of FIG. 13, Vdata can maintain the voltage of Vref3 during the light emitting period (D), and instead, P2 can be set to Low at the timing of changing Vdata from Vref3 to Vref4 in FIG. 12 to reduce the light emitting duty to 1/X times. The non-light emitting state is set when P2 is set to Low at the timing of changing Vdata from Vref3 to Vref4 in FIG. 12.

As described, according to the present embodiment, the pixels emit light at two kinds of light emitting levels based on the dummy pulse to display the gradation if the image data is high luminance data, and the luminance unevenness is suppressed. If the image data is low luminance data, the luminance unevenness can be excellently suppressed by setting the second light emitting level with lower luminance between the two kinds of light emitting levels to almost zero, reducing the light emitting period of the first light emitting level with higher luminance to 1/X times, and increasing the light emitting intensity by X times.

### Third Embodiment

Although the overall configuration of the display apparatus and the pixel circuit of the present embodiment are the same as in the second embodiment, light emitting patterns in the light emitting period (D) according to the result of the image data determination unit are different from the second embodiment.

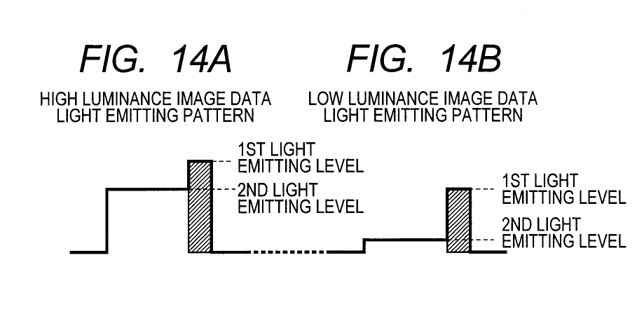

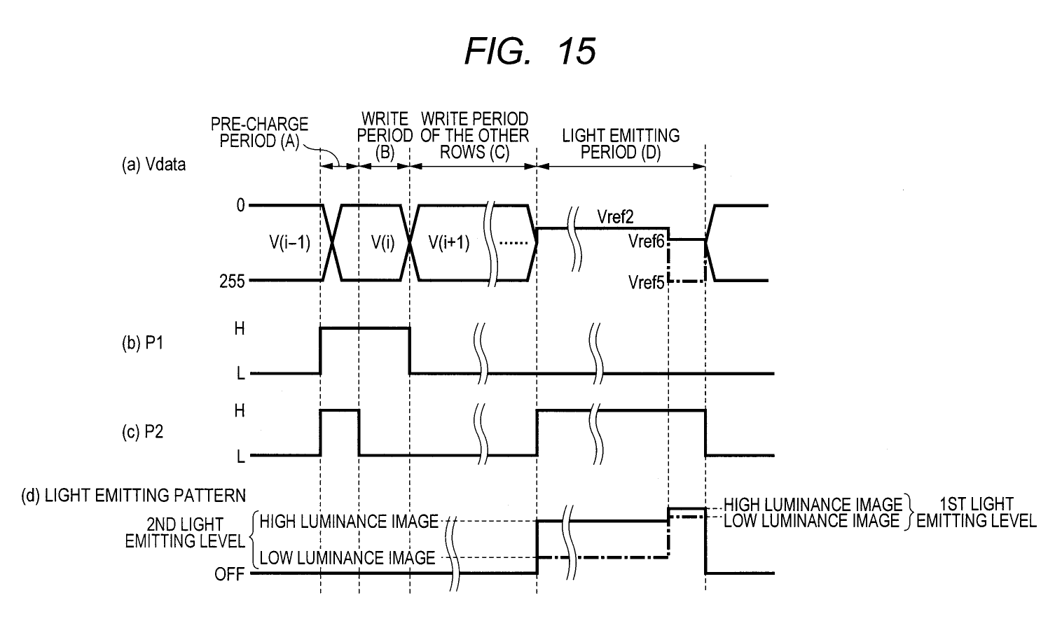

FIGS. 14A and 14B are schematic diagrams of light emitting patterns of a high luminance image and a low luminance image of the present embodiment. FIG. 15 is a timing chart illustrating an example of operation of the present embodiment.

In the present embodiment, if the image data determination unit determines that the image data is high luminance image data, the luminance of the first light emitting level is reduced to near the second light emitting level.

In the timing chart of FIG. 15, the voltage Vdata of the data lines 7 is set to Vref2 to emit light at the second light emitting level in the light emitting period (D). Vref2 is set to the same voltage when the image data is determined to be the high luminance image data and when the image data is determined to be the low luminance image data. The image data is different in most pixels between when the image data is determined to be the high luminance image data and when the image data is determined to be the low luminance image data, and the light emitting levels are different.

The light is then emitted at the first light emitting level. At this point, if the image data is determined to be low luminance image data, the voltage Vdata of the data lines 7 is set to Vref5. On the other hand, if the image data is determined to be high luminance image data, the voltage Vdata of the data lines 7 is set to Vref6. This is to reduce the luminance of the first light emitting level to near the luminance of the second light emitting level. Vref6 is a voltage higher than Vref5 and is a voltage closer to Vref2 than to Vref5.

In this way, the peak power can be suppressed by limiting the value of the first light emitting level to obtain desired luminance in the high luminance image data display. The luminance unevenness is close to the large current range of the transistor in the higher luminance, and the luminance unevenness is not noticeable. Therefore, the luminance unevenness is not easily observed even if the luminance difference between the first light emitting level and the second light emitting level is not enlarged.

On the other hand, the luminance of the image data is low in the low luminance image data display.

Therefore, the light emitting quantity at the second light emitting level is reduced, and at the same time, the momentary luminance at the first light emitting level is increased. Since the image is the low luminance image, the reference voltage is set so that the light emitting quantity at the second light emitting level is small in order to obtain desired luminance even if the momentary luminance at the first light emitting level is increased. The luminance unevenness is close to the small current range of the transistor in the lower luminance, and the luminance unevenness is noticeable. Therefore, the first light emitting level is increased to make the luminance unevenness hard to observe.

In the image data near the boundary between when the image data is determined to be the high luminance image data and when the image data is determined to be the low luminance image data, the luminance at the first light emitting level may be brighter when the image data is determined to be the low luminance image data. However, the gradation is displayed based on the sum of the light emitting quantity in the period of the light emission at the first light emitting level and the light emitting quantity in the period of the light emission at the second light emitting level. Therefore, the continuity of the gradation display (y characteristics) can be maintained by adjusting the image data in advance.

In this way, the control circuit performs the following (3) to (5) controls in the present embodiment in addition to the (1) and (2) controls of the second embodiment.

(3) The light emitting level of the organic EL element during the period of supplying the first voltages Vref5 and Vref6 is controlled to be higher than the light emitting level of the organic EL element during the period of supplying the second voltage Vref2.

(4) The difference between the first voltage and the second voltage is controlled to be smaller when the image data is determined to be high luminance data than when the image data is determined to be low luminance data.

(5) The period of supplying the first voltage and the period of supplying the second voltage are equal when the image data is determined to be high luminance data, compared to when the image data is determined to be low luminance data.

As described, the luminance unevenness can be suppressed when the image data is determined to be low luminance data and when the image data is determined to be high luminance data in the present embodiment.

### Fourth Embodiment

Although the overall configuration of the display apparatus and the pixel circuit of the present embodiment are the same as in the second and third embodiments, light emitting patterns in the light emitting period (D) according to the result of the image data determination unit are different from those of the second and third embodiments.

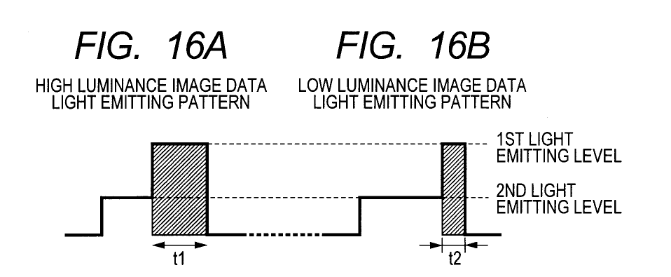

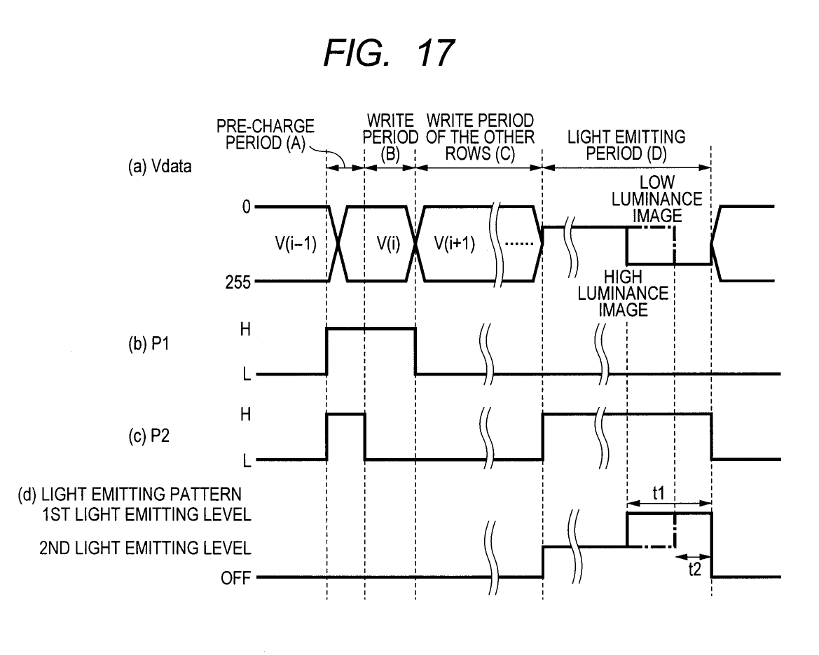

FIGS. 16A and 16B are schematic diagrams of light emitting patterns of a high luminance image and a low luminance image of the present embodiment. FIG. 17 is a timing chart illustrating an example of operation of the present embodiment.

If the image data determination unit determines that the image data is high luminance image data, the light emitting period at the second light emitting level is reduced, and a light emitting period (t1) at the first light emitting level is increased. In the timing chart of FIG. 17, the period (t1) of light emission at the first light emitting level is increased as in a solid line section of the light emitting period (D). On the other hand, if the image data determination unit determines that the image data is low luminance image data, the light emitting period at the second light emitting level is increased, and a light emitting period (t2) at the first light emitting level is reduced. In the timing chart of FIG. 17, the period (t2) of light emission at the first light emitting level is reduced as in a broken line section of the light emitting period (D).

In this way, desired high luminance can be easily obtained by increasing the period of the first light emitting level and increasing the light emitting quantity at the first light emitting level in the high luminance image data display. The light emitting quantity of the first light emitting level, which is a large current range of the transistor, increases and the luminance unevenness is not easily observed. On the other hand, the light emitting period at the first light emitting level is reduced in the low luminance image, and low gradation can be easily expressed. More specifically, black of the image displayed on the display apparatus settles and becomes deep, and excellent image quality can be obtained.

As described, image quality with good contrast can be obtained in the present embodiment while suppressing the luminance unevenness by the dummy pulse.

### Fifth Embodiment

Although the overall configuration of the display apparatus and the pixel circuit of the present embodiment are the same as in the second to fourth embodiments, light emitting patterns in the light emitting period (D) according to the result of the image data determination unit are different from those of the second to fourth embodiments. Since the luminance unevenness suppression effect is smaller than in other embodiments, the present embodiment can be suitably applied when the luminance unevenness of the display apparatus is small.

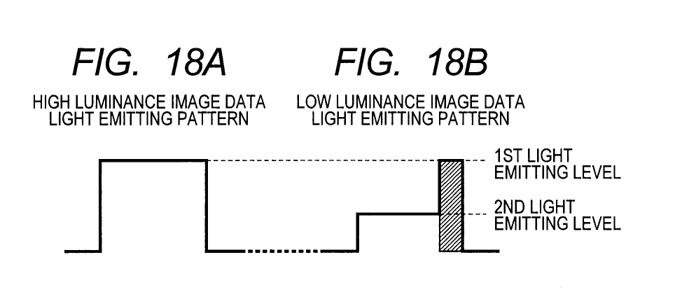

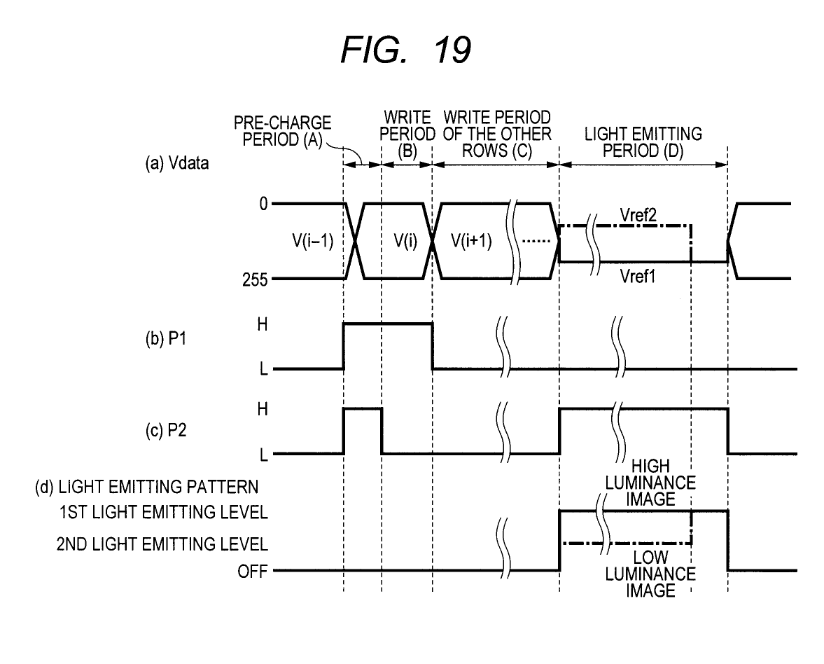

FIGS. 18A and 18B are schematic diagrams of light emitting patterns of a high luminance image and a low luminance image of the present embodiment. FIG. 19 is a timing chart illustrating an example of operation of the present embodiment.

If the image data determination unit determines that the image data is high luminance image data, the light is emitted only at the first light emitting level. As shown in a slid line section of the light emitting period (D) of FIG. 19, Vdata is set to Vref1 in the light emitting period, and light is emitted only at the first light emitting level.

On the other hand, if the image data determination unit determines that the image data is low luminance image data, light is emitted at two kinds of light emitting levels, the first light emitting level and the second light emitting level. As in a broken line section of the light emitting period (D) of FIG. 19, the voltage Vdata of the data line 7 is set to Vref2 in the first half, and the voltage Vdata of the data line 7 is set to Vref1 in the second half of the light emitting period (D). Consequently, the light is emitted at the second light emitting level in the first half of the light emitting period (D), and the light is emitted at the first light emitting level in the second half.

In this way, desired high luminance can be easily obtained by increasing the period of the first light emitting level and increasing the light emitting quantity at the first light emitting level in the high luminance image data display. The luminance unevenness of the display apparatus is small, and the luminance unevenness is not easily observed at the first light emitting level that is a relatively large current range of the transistor. Since the momentary peak current can be suppressed, the maximum value of the power consumption can be suppressed. Meanwhile, the light is emitted at two kinds of light emitting levels in the low luminance image, and the luminance unevenness is not easily observed.

As described, the control circuit performs the following (1) and (2) controls in the present embodiment.

(1) The data voltage is supplied to the pixels through the data line, and the data voltage is written in the storage capacitor in one frame period. If the mode is determined to be the high luminance mode, the predetermined voltage Vref1 is supplied to the reference voltage line. If the data is determined to be the low luminance data, the predetermined different first voltage Vref1 and second voltage Vref2 are supplied to the reference voltage line in this order or reversed order.

(2) If the image data is determined to be high luminance data, in each pixel, the light emitting quantity of the organic EL element during the period of supplying the predetermined voltage is controlled to be equal to the light emitting quantity of the organic EL element determined according to the image data. If the mode is determined to be a low luminance mode, in each pixel, the sum of the light emitting quantity of the organic EL element during the period of supplying the first voltage and the light emitting quantity of the organic EL element during the period of supplying the second voltage is controlled to be equal to the light emitting quantity of the organic EL element determined in advance according to the image data.

Even if the control circuit as in the present embodiment is not included, the effect of the present invention can be attained by carrying out the drives of (1) and (2) in each frame period in a plurality of data lines and a plurality of reference voltage lines arranged on the organic EL display apparatus.

As described, an increase in the power consumption is suppressed while limiting the luminance unevenness by the dummy pulse in the present embodiment.

### Sixth Embodiment

Although the overall configuration of the display apparatus of the present embodiment is the same as in the second to fifth embodiments, the pixel circuit is different.

The light emitting period is the same for all pixels in the first to fifth embodiments, i.e. writing is performed row by row. After the writing of all pixels, all pixels emit light at the same time in the driving method and the light emitting patterns. Meanwhile, the present embodiment includes the pixel circuit 2 that performs scan-type light emission row by row as illustrated in FIG. 20. More specifically, writing of the data voltage in the storage capacitor and light emissions of the organic EL element during the period of supplying the first voltage and during the period of supplying the second voltage after the writing are successively performed for all pixels row by row. If the light emitting patterns can be controlled, the effect of the present invention can be attained without depending on the configuration of the pixel circuit.

Hereinafter, the driving method of the present embodiment will be described in detail with reference to FIGS. 20 to 23.

FIG. 20 is an example of the pixel circuit 2 including the organic EL element suitably used in the display apparatus according to the present invention such as the display apparatus of FIG. 1. In FIG. 20, the pixel circuit 2 includes an organic EL element, a current supply circuit unit that is a circuit for supplying a current according to the gradation display data to the organic EL element, and a plurality of signal input wiring and power supply wiring connected to the current supply circuit unit.

The current supply circuit unit includes the driving transistor Tr2 that supplies a current according to the voltage of the gate electrode to the organic EL element and a pixel circuit selecting unit that selects a pixel circuit for writing. The current supply circuit unit further includes the storage capacitor C1 that holds the voltage of the gate electrode of the driving transistor Tr2, a light emitting period control unit, and a light emitting intensity control unit. Although a PMOS is used for the driving transistor Tr2 in FIG. 20, an NMOS may be used. Although an NMOS is used for the transistor Tr1, a PMOS may be used. TFTs are suitably used for the driving transistor Tr2 and the transistor Tr1.

An example of the pixel circuit selecting unit includes the transistor Tr1, and the gate is connected to the control line 5 for supplying the control signal P1. The gate of the driving transistor Tr2 is connected to one terminal of the storage capacitor C1, and the control line 6 for supplying the control signal P2 is connected to the other terminal.

In the pixel circuit of FIG. 20, the light emitting period control unit and the light emitting intensity control unit play the roles based on a combination of the storage capacitor C1 and the control line 6. To control the light emitting period, i.e. to change the light emitting state to the light-out state, the voltage of the control line 6 can be significantly increased to set a gate voltage so as to turn off the driving transistor Tr2. Similarly, to change the light emitting level, the gate voltage of the driving transistor Tr2 is changed by changing the voltage of the control line 6. Therefore, the light emitting level can be changed without rewriting the gradation display data of the pixel circuit.

The data line 7 for inputting the data voltage Vdata as gradation display data and the plurality of control lines 5 and 6 for inputting control signals are used for the plurality of signal input wiring for inputting signals to the current supply circuit unit. The current supply circuit unit can be operated including the light emitting period control and the light emitting level control just by the scan signal P1 for selecting pixels, such as by changing the voltage of the power supply wiring. In that case, the number of control lines can be one. However, a necessary number of control lines can be used if a plurality of signals are necessary to simply control the operation of the current supply circuit unit.

As illustrated in FIG. 20, the current supply circuit unit includes a data voltage setting unit, and the control line 6 controls the connection between the data line 7 and the electrode of the storage capacitor closer to the data line 7. The data voltage setting unit illustrated in FIG. 20 may not be included if the voltage of the data line 7 can be applied to the electrode of the storage capacitor C1 closer to the data line 7.

For the power supply wiring, high-voltage power wiring (+VCC wiring) is connected to the source of the driving transistor Tr2, and low-voltage power wiring (CGND wiring) is connected to the cathode of the organic EL element in FIG. 20. However, the arrangement is not limited to this. For example, the high-voltage power wiring may be connected to the anode of the organic EL element. The cathode of the organic EL element may be connected to one terminal of the driving transistor Tr2, and the low-voltage power wiring may be connected to the other end of the driving transistor.

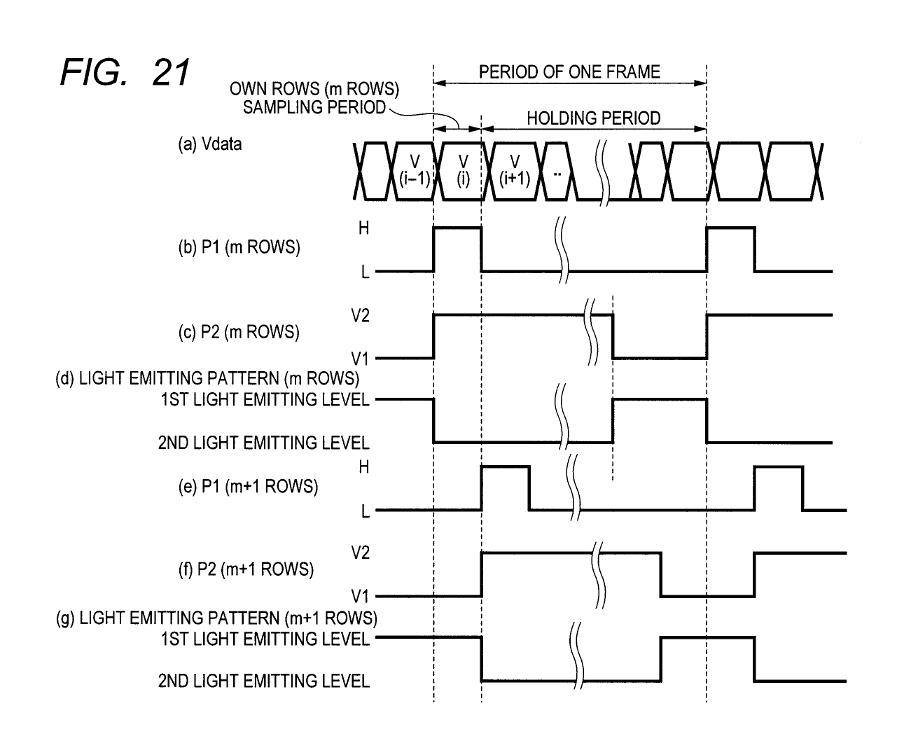

In relation to the operation of the pixel circuit of FIG. 20, a driving method when the image data is determined to be high luminance image data will be described with reference to the timing chart of FIG. 21.

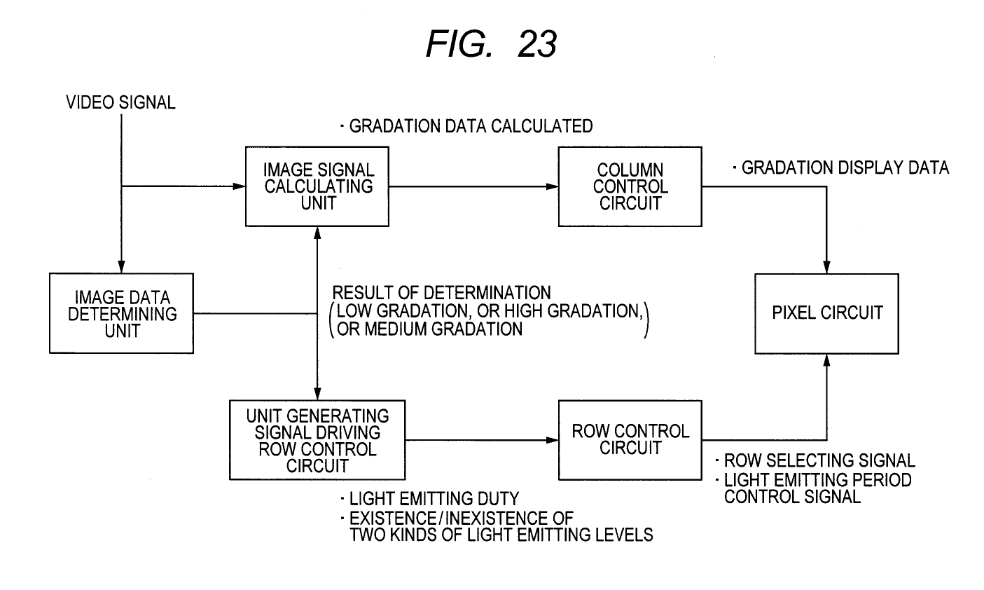

In a writing row (m-th row) of the pixel circuit, the control line 5 is set to a Hi level in the first sampling period of one frame period, and the electrode of the storage capacitor C1 closer to the data line 7 and the data line 7 are energized to set the data voltage Vdata1 to the electrode of the storage capacitor C1 closer to the data line 7. In this case, the control line 6 is set to the Hi level. The pixel circuit 2 supplies a current for light emission at the first light emitting level to the organic EL element. Vdata1 is a voltage with lower luminance than the data voltage Vdata0 according to the input video data in the video data calculating unit of FIG. 23.

The control line 5 is set to a Low level, and the electrode of the storage capacitor C1 closer to the data line 7 and the data line 7 are disconnected to cause the storage capacitor C1 to hold the data voltage Vdata1.

The control line 6 is set to the Low level. As a result, the voltage of the gate of the driving transistor Tr2 is reduced from Vdata1 to Vdata2 according to the displacement of the control line 6. At this point, the pixel circuit supplies the current for light emission at the second light emitting level to the organic EL element.

Writing of the next row (m+1-th row) after the writing row (m-th row) and the second light emitting level are started at a timing delayed by one horizontal period from the m-th row. In this way, the start timings of the writing and the second light emitting level are sequentially scanned.

Although the driving transistor Tr2 is a PMOS in the example, if the driving transistor Tr2 is an NMOS, the same drive can be realized by reversing the Hi level and the Low level of the control line 6.

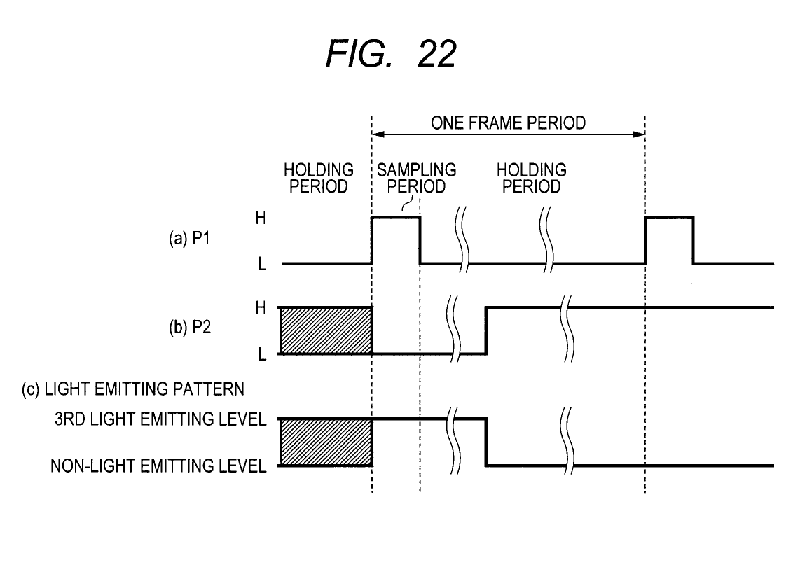

If a dummy pulse is input to a low gradation image to perform the drive as illustrated in FIG. 21, the image quality or the contrast may be degraded. Therefore, the luminance unevenness is suppressed by a different driving method in the low gradation image. The driving method when the image data is determined to be low luminance image data will be described with reference to the timing chart of FIG. 22.

The control line 5 is set to the Hi level in the first sampling period of one frame period of the pixel circuit 2, and the electrode of the storage capacitor C1 closer to the data line 7 and the data line 7 are energized to set the data voltage Vdata3 to the electrode of the storage capacitor C1 closer to the data line 7. In this case, if the control line 6 is set to the Low level, the pixel circuit 2 supplies a current for light emission at a third light emitting level to the organic EL element.

Vdata3 is a voltage set to higher luminance according to the ratio of the reduction of the light emitting duty in a video data calculating unit of FIG. 23, compared to the data voltage Vdata0 according to the input video data (image data). Since the amount of current is large, the light can be emitted in a range with small variations and without noticeable luminance unevenness.

The control line 5 is set to the Low level, and the electrode of the storage capacitor C1 closer to the data line 7 and the data line 7 are disconnected to cause the storage capacitor C1 to hold the data voltage Vdata3.

The control line 6 is set to the Hi level. As a result, the voltage of the gate of the driving transistor Tr2 increases from Vdata3 to Vdata4 according to the displacement of the control line 6. At this point, the supply of current to the organic EL element becomes almost zero, and the pixel circuit enters a substantially non-light emitting state. In this way, the light emitting period is controlled to suppress the luminance unevenness.

Although the driving transistor Tr2 is a PMOS in the example, if the driving transistor Tr2 is an NMOS, the same drive can be realized by reversing the Hi level and the Low level of the control line 6.

If the drive as in FIG. 22 is performed by reducing the light emitting duty in the high gradation image, the maximum amount of the momentary current is too large to obtain a desired current, and the power consumption may increase. Therefore, the light is emitted at two kinds of luminance as in FIG. 21 in the high gradation image to suppress the luminance unevenness while suppressing the maximum amount of current of the entire display apparatus.

However, in a display apparatus with low power consumption, the luminance unevenness may be suppressed by emitting light at two kinds of luminance without dividing the driving method based on the image data as in the first embodiment.

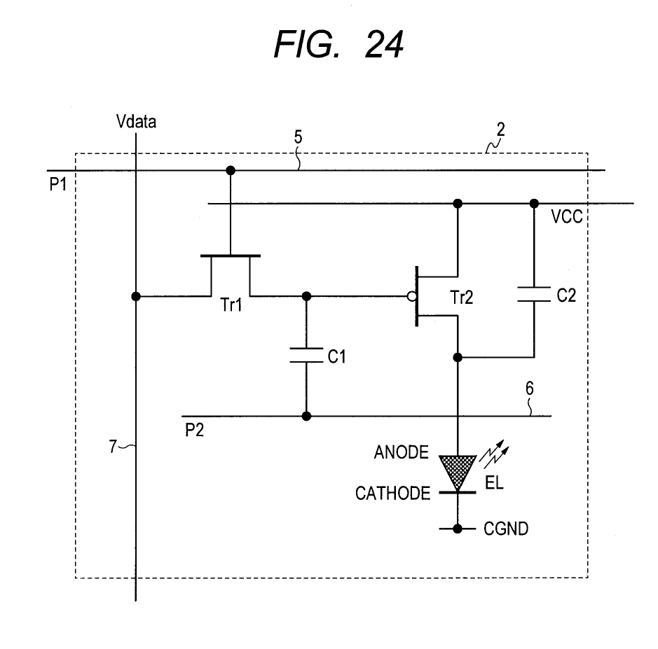

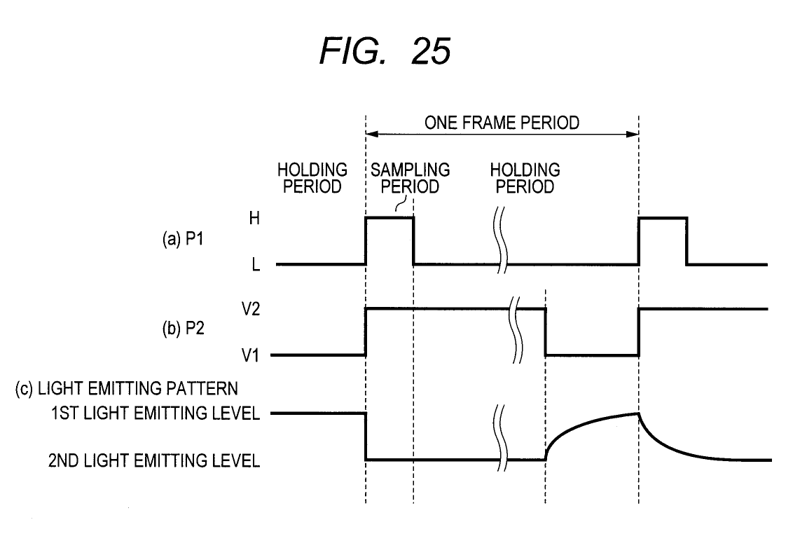

Another example of circuit configuration includes a configuration as in FIG. 24. The pixel circuit is a pixel circuit provided with a capacitor C2 between the anode of the organic EL element and the constant-voltage power line (+VCC wiring), the capacitor 2 additionally arranged on the pixel circuit of FIG. 20. FIG. 25 illustrates a timing chart and a light emitting pattern indicating an example of the driving method of the pixel circuit of FIG. 24.

Although the driving method of the input control signal, etc., is exactly the same as in FIG. 21, the light emitting pattern is different because the capacitor C2 is added. Not all current supplied from the driving transistor Tr2 flows into the organic EL element when the level changes from the second light emitting level to the first light emitting level, but part of the current flows so as to charge the capacitor C2. Therefore, the change in the luminance is modest, and the light emitting level does not increase much.

When the level changes from the first light emitting level to the second light emitting level, the electricity charged to C2 flows to the organic EL element, and the change in the luminance is modest. As a result, a current with two kinds of sizes flows from the driving transistor Tr2 in almost the same way as in FIG. 21, and a current that makes the luminance unevenness difficult to observe by suppressing the variations in the transistor is supplied. On the other hand, the change in the current is modest in the organic EL element because of the capacitor C2, and the maximum current can be suppressed. As a result, an increase in the power consumption can be suppressed, and degradation of the organic EL element can be suppressed.

As described, dummy pulse light emission based on a large current with small variations can be used by adding a dummy pulse only in the high gradation display to display the gradation in the light emission at two kinds of luminance even in the display apparatus that performs scan-type light emission in the present embodiment, regardless of the configuration of the pixel circuit. Therefore, the luminance unevenness can be suppressed. In the low gradation display which may reduce the contrast, the luminance unevenness can be suppressed by reducing the light emitting duty to emit light based on a large current with small variations.

### Seventh Embodiment

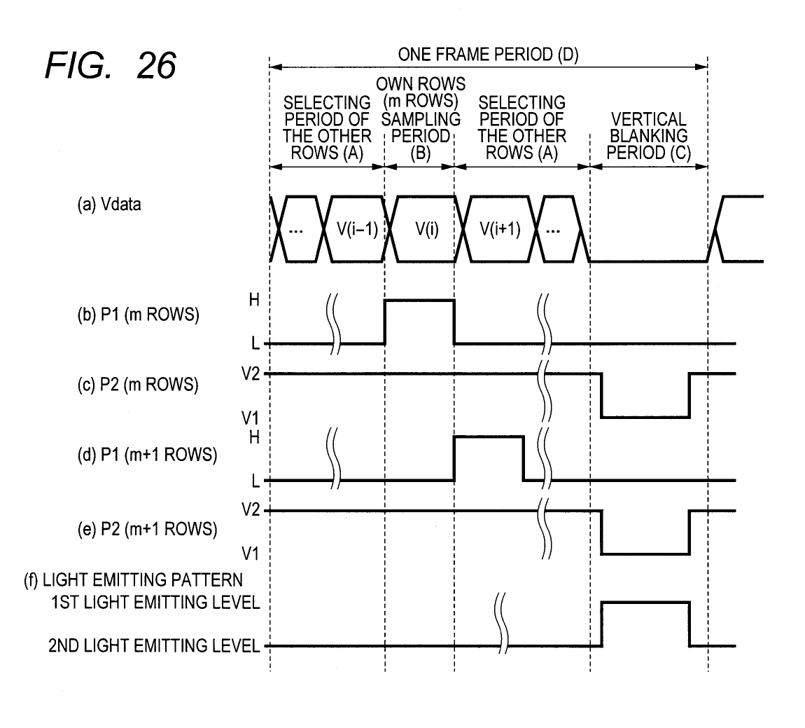

In the display apparatus and the driving method of the display apparatus described in the sixth embodiment, the light emission is sequentially started every time data is written row by row. The timing for starting the light emission at the first light emitting level and the second light emitting level according to the sequential light emission is also sequentially scanned. Whereas, although it is the same that the sequential light emission is started at the second light emitting level every time data is written row by row in the present embodiment, the timing for the light emission at the first light emitting level is the same in all rows. The pixel circuit can be applied to the pixel circuit of FIG. 20. FIG. 26 illustrates the timing chart.

Although the writing is scanned row by row, the light is emitted at the first light emitting level in all rows at once in the vertical blanking period in one frame period. Although the first light emitting level and the second light emitting level of an (f) light emitting pattern are different depending on the data written in the pixels, the timing of changing the level from the second light emitting level to the first light emitting level is common in all pixels (or in a plurality of rows).

An advantage of the driving method is that the control signal P2 does not have to be scanned as compared to the sixth embodiment, and the pulse can be input to all cells at once. More specifically, the control signal P2 is common in all rows. As a result, the scanning circuit for scanning the control signal P2 can be reduced, and a simple display apparatus with a small peripheral circuit unit can be used.

### Eighth Embodiment

The present embodiment is an example in which the display apparatus of the first to seventh embodiments is used for an electronic device.

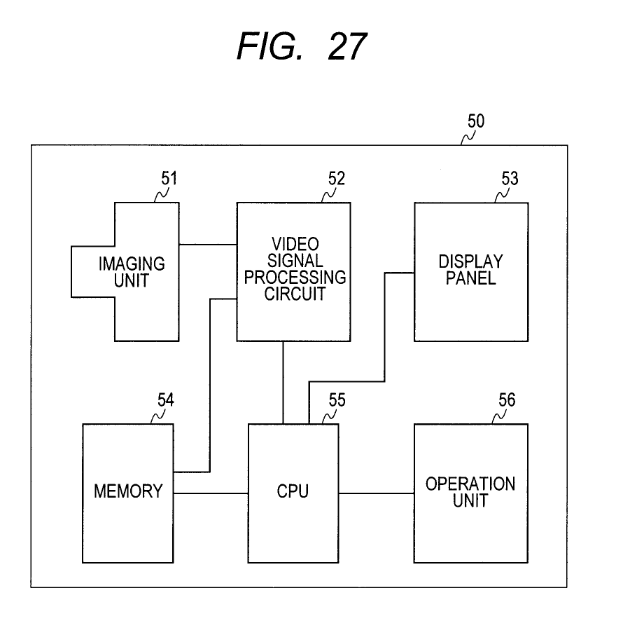

FIG. 27 is a block diagram of an example of a digital still camera system illustrating an eighth embodiment according to the present invention. In FIG. 27, denotes a digital still camera system, 51 denotes an imaging unit, 52 denotes a video data processing circuit, 53 denotes a display panel, 54 denotes a memory, 55 denotes a CPU, and 56 denotes an operation unit. The display apparatus according to the present invention is used for the display panel 53.

In FIG. 27, the video data processing circuit 52 applies signal processing to a video taken by the imaging unit 51 or a video recorded in the memory 54, and the video can be watched on the display panel 53. The CPU 55 controls the imaging unit 51, the memory 54, and the video data processing circuit 52 based on input from the operation unit 56 to perform imaging, recording, reproducing, and displaying suitable for the situation. In addition, the display panel 53 can be used as display units of various electronic devices.

The use of the display apparatus according to the present invention can constitute, for example, an information display apparatus. The information display apparatus is in a form of, for example, a cell phone, a portable computer, a still camera, or a video camera. Alternatively, the apparatus realizes a plurality of functions of the devices. The information display apparatus includes an information input unit. For example, the information input unit includes an antenna in the case of a cell phone. The information input unit includes an interface unit for a network in the case of a PDA or a portable PC. The information input unit includes a sensor unit based on a CCD or a CMOS in the case of a still camera or a movie camera.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-227208, filed Oct. 7, 2011, and No. 2011-208917, which are hereby incorporated by reference herein in their entirety.

What is claimed is:

1. A display apparatus comprising:
a plurality of pixels, each including a light emitting element, a driving transistor for supplying the light emitting element with a current according to a voltage of a gate electrode of the driving transistor, and a storage capacitor having an one terminal connected to the gate electrode of the driving transistor for holding the voltage of the gate electrode of the driving transistor;
a data line for supplying a data voltage according to an image data to the gate electrode of the driving transistor;
a reference voltage line for supplying a reference voltage to the gate electrode of the driving transistor; and
a control circuit for controlling the data voltage supplied through the data line, and for controlling the reference voltage supplied through the reference voltage line, wherein,
during a one frame period, the control circuit supplies the data voltage through the data line to each of the pixels through the data line, to write the data voltage in the storage capacitor, and, thereafter, supplies to the reference voltage line respectively different first and second voltages successively in this order or reversed order, so that,
in each of the pixels, a sum of a light emitting quantity of the light emitting element during a period of supplying the first voltage and a light emitting quantity of the light emitting element during a period of supplying the second voltage equals to a predetermined light emitting quantity of the light emitting element predetermined according to the image data.

2. A display apparatus comprising:
a plurality of pixels, each including a light emitting element, a driving transistor for supplying the light emitting element with a current according to a voltage of a gate electrode of the driving transistor, and a storage capacitor having an one terminal connected to the gate electrode of the driving transistor for holding the voltage of the gate electrode of the driving transistor;
a data line for supplying a data voltage according to an image data to the gate electrode of the driving transistor;
a reference voltage line for supplying a reference voltage to the gate electrode of the driving transistor;
a control circuit for controlling the data voltage supplied through the data line, and for controlling the reference voltage supplied through the reference voltage line; and
an image data determining unit for determining as to whether the image data is a high luminance data or a low luminance data based on an average luminance of the image data, wherein,
during a one frame period, the control circuit supplies the data voltage through the data line to each of the pixels through the data line, to write the data voltage in the storage capacitor, and, thereafter, supplies to the reference voltage line respectively different first and second voltages determined based on a result of the determination by the image data determining unit, successively in this order or reversed order, so that,
in each of the pixels, a sum of a light emitting quantity of the light emitting element during a period of supplying the first voltage and a light emitting quantity of the light emitting element during a period of supplying the second voltage equals to a predetermined light emitting quantity of the light emitting element predetermined according to the image data.

3. The display apparatus according to claim 2, wherein
the control circuit controls, such that
a light emitting level of the light emitting element during the period of supplying the first voltage is higher than a light emitting level of the light emitting element during the period of supplying the second voltage,
when the image data determining unit determines that the image data is the low luminance data, the period of supplying the first voltage is set 1/X (X>1) times as large as a light emitting period determined by a predetermined light emitting duty, while the light emitting element emits no light during the period of supplying the second voltage, and
the light emitting quantity of the light emitting element during the period of supplying the first voltage equals to a light emitting quantity of the light emitting element predetermined according to the image data.

4. The display apparatus according to claim 2, wherein
the control circuit controls, such that
a light emitting level of the light emitting element during the period of supplying the first voltage is higher than a light emitting level of the light emitting element during the period of supplying the second voltage,
a difference between the first and second voltages at a time determining the image data as the high luminance data is smaller than a difference between the first and second voltages at a time determining the image data as the low luminance data, and
the period of supplying the first voltage, the second voltage and the period of supplying the second voltage are respectively equal at both of the times of determining the image data as the low luminance data and the high luminance data.

5. A display apparatus comprising:
a plurality of pixels, each including a light emitting element, a driving transistor for supplying the light emitting element with a current according to a voltage of a gate electrode of the driving transistor, and a storage capacitor having an one terminal connected to the gate electrode of the driving transistor for holding the voltage of the gate electrode of the driving transistor;
a data line for supplying a data voltage according to an image data to the gate electrode of the driving transistor;
a reference voltage line for supplying a reference voltage to the gate electrode of the driving transistor;
a control circuit for controlling the data voltage supplied through the data line, and for controlling the reference voltage supplied through the reference voltage line; and
an image data determining unit for determining as to whether the image data is a high luminance data or a low luminance data based on an average luminance of the image data, wherein,
during a one frame period, the control circuit supplies the data voltage through the data line to each of the pixels through the data line, to write the data voltage in the storage capacitor, and, thereafter, in response to the determination as the high luminance data by the image data determining unit, supplies a predetermined voltage to the reference voltage line, and, in response to the determination as the low luminance data by the image data determining unit, supplies to the reference voltage line respectively different first and second voltages successively in this order or reversed order, so that,
at the time of the determination as the high luminance data, in each of the pixels, a light emitting quantity of the light emitting element during a period of supplying the predetermined voltage equals to the predetermined light emitting quantity of the light emitting element predetermined according to the image data, while,
at the time of the determination as the low luminance data, in each of the pixels, a sum of a light emitting quantity of the light emitting element during a period of supplying the first voltage and a light emitting quantity of the light emitting element during a period of supplying the second voltage equals to a predetermined light emitting quantity of the light emitting element predetermined according to the image data.

6. The display apparatus according to claim 2, wherein
the image data determining unit determines the image data as the high or low luminance data, by one frame by one frame.

7. The display apparatus according to claim 2, wherein
the image data determining unit determines the image data as the high or low luminance data, by plural frames by plural frames.

8. The display apparatus according to claim 1, wherein
the control circuit controls the first and second voltages, such that one of the voltage of the gate electrode after supplying the first voltages and the gate electrode after supplying the second voltages is larger than a voltage of the gate electrode at a time of applying a voltage for obtaining a predetermined light emitting quantity from the light emitting element predetermined according to the image data, by a light emitting of the light emitting element at a constant light emitting level during a one frame period, after wiring the data voltage in the storage capacitor, and such that
the other of the voltage of the gate electrode after supplying the first voltages and the gate electrode after supplying the second voltages is smaller than the voltage of the gate electrode at the time of applying the voltage for obtaining the predetermined light emitting quantity from the light emitting element predetermined according to the image data, by the light emitting of the light emitting element at the constant light emitting level during the one frame period, after wiring the data voltage in the storage capacitor.

9. The display apparatus according to claim 1, wherein
a light emitting level of the light emitting element during the period of supplying the first voltage and a light emitting level of the light emitting element during the period of supplying the second voltage are different per each of light emitting colors.

10. The display apparatus according to claim 1, wherein
the data line and the reference voltage line are the same wiring.

11. The display apparatus according to claim 1, wherein
the plurality of pixels are arranged in a matrix, and
the writing the data voltage in the storage capacitor, the light emitting of the light emitting element during the period of supplying the first voltage and the light emitting of the light emitting element during the period of supplying the second voltage are performed for all of the pixels one row by one row.

12. A digital still camera provided with, as a display panel, a display apparatus according to claim 1.

13. A driving method of a display apparatus comprising:
a plurality of pixels, each including a light emitting element, a driving transistor for supplying the light emitting element with a current according to a voltage of a gate electrode of the driving transistor, and a storage capacitor for holding the voltage of the gate electrode of the driving transistor;
a plurality of data lines for supplying a data voltage according to an image data to the gate electrode of the driving transistor; and
a plurality of reference voltage lines for supplying a reference voltage to the gate electrode of the driving transistor, wherein the method comprises steps of:
supplying the data voltage through the data line to each of the pixels, one frame period by one frame period, to write the data voltage in the storage capacitor, and, thereafter, supplying to the reference voltage line respectively different first and second voltages successively in this order or reversed order; and
setting a sum of a light emitting quantity of the light emitting element during a period of supplying the first voltage and a light emitting quantity of the light emitting element during a period of supplying the second voltage equals to a predetermined light emitting quantity of the light emitting element predetermined according to the image data.

14. A driving method of a display apparatus comprising:
a plurality of pixels, each including a light emitting element, a driving transistor for supplying the light emitting element with a current according to a voltage of a gate electrode of the driving transistor, and a storage capacitor for holding the voltage of the gate electrode of the driving transistor;
a plurality of data lines for supplying a data voltage according to an image data to the gate electrode of the driving transistor;
a plurality of reference voltage lines for supplying a reference voltage to the gate electrode of the driving transistor; and
an image data determining unit for determining as to whether the image data is a high luminance data or a low luminance data based on an average luminance of the image data, wherein the method comprises steps of:
supplying the data voltage through the data line to each of the pixels, one frame period by one frame period, to write the data voltage in the storage capacitor, and, thereafter, supplying to the reference voltage line respectively different first and second voltages determined based on a result of the determination by the image data determining unit, successively in this order or reversed order; and
setting a sum of a light emitting quantity of the light emitting element during a period of supplying the first voltage and a light emitting quantity of the light emitting element during a period of supplying the second voltage equals to a predetermined light emitting quantity of the light emitting element predetermined according to the image data.

15. A driving method of a display apparatus comprising:
a plurality of pixels, each including a light emitting element, a driving transistor for supplying the light emitting element with a current according to a voltage of a gate electrode of the driving transistor, and a storage capacitor for holding the voltage of the gate electrode of the driving transistor;
a plurality of data lines for supplying a data voltage according to an image data to the gate electrode of the driving transistor;
a plurality of reference voltage lines for supplying a reference voltage to the gate electrode of the driving transistor; and
an image data determining unit for determining as to whether the image data is a high luminance data or a low luminance data based on an average luminance of the image data, wherein the method comprises steps of:
supplying the data voltage through the data line to each of the pixels, one frame period by one frame period, to write the data voltage in the storage capacitor, and, thereafter,
supplying a predetermined voltage to the reference voltage line, in response to the determination as the high luminance data by the image data determining unit;
supplying to the reference voltage line respectively different first and second voltages successively in this order or reversed order, in response to the determination as the low luminance data by the image data determining unit;
setting, in each of the pixels, a light emitting quantity of the light emitting element during a period of supplying the predetermined voltage as being equal to the predetermined light emitting quantity of the light emitting element predetermined according to the image data, at the time of the determination as the high luminance data while
setting, in each of the pixels, a sum of a light emitting quantity of the light emitting element during a period of supplying the first voltage and a light emitting quantity of the light emitting element during a period of supplying the second voltage as being equal to a predetermined light emitting quantity of the light emitting element predetermined according to the image data, at the time of the determination as the low luminance data.
